(19) United States
(12) Patent Application Publication
(10) Pub. No.: US 2024/0185787 A1
(43) Pub. Date: Jun. 6, 2024

(54) DIGITAL DRIVING DISPLAYS

(71) Applicant: Meta Platforms Technologies, LLC, Menlo Park, CA (US)

(72) Inventors: Junhan HAN, Redmond, WA (US); Yun WANG, Bellevue, WA (US)

(21) Appl. No.: 18/515,092

(22) Filed: Nov. 20, 2023

Related U.S. Application Data
(60) Provisional application No. 63/386,316, filed on Dec. 6, 2022.

(51) Int. Cl. G09G 3/3233

(52) U.S. Cl. CPC G09G 3/3233; G09G 3/002; G09G 2300/0465; G09G 2300/0857; G09G 2310/0281; G09G 2310/08; G09G 2320/0233; G09G 2330/021

(57) ABSTRACT

A display drive circuit includes a plurality of lines of cells. A line of cells of the plurality of lines of cells includes a plurality of pixel drive circuits for a plurality of light emitters, and a data line including an array of data bit storage devices connected serially (e.g., by an array of switches) and configured to shift display data bits along the data line. An output of each data bit storage device of the array of data bit storage devices is connected (e.g., through a switch) to a corresponding pixel drive circuit of the plurality of pixel drive circuits. The pixel drive circuit includes, for example, a digital memory cell, and a switch controlled by a data bit stored in the digital memory cell to turn on or off a drive current to a corresponding light emitter.

### CROSS-REFERENCE TO RELATED APPLICATIONS

This application claims the benefit of and priority to U.S. Provisional Application No. 63/386,316, filed Dec. 6, 2022, entitled “Digital Driving Displays,” which is herein incorporated by reference in its entirety for all purposes.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may include an image source (e.g., a display panel) and optional display optics, and may display virtual objects or combine images of real objects with virtual objects, as in virtual reality (VR), augmented reality (AR), or mixed reality (MR) applications.

### SUMMARY

This disclosure relates generally to display systems. More specifically, and without limitation, techniques disclosed herein relate to digital driving displays. Various inventive embodiments are described herein, including devices, systems, circuits, structures, methods, processes, and the like.

According to certain embodiments, a fully digital driving micro-display and the operations of the digital driving micro-display are disclosed. In the digital driving micro-display disclosed herein, pixels in a row or a column may be connected to a data line, where the data line may include serially connected gates for latching and sending digital data bits for pages (e.g., subframes) of an image frame to the pixels. For each page of the image frame, a display data bit may be sent from a data driver to a gate connected to a first pixel in each row or column in one clock cycle, and the gate may, in the next clock cycle, send the received display data bit to the gate connected to the next pixel in the row or column, and also receive a new display data bit from the data driver. In this way, display data bits of a page may be shifted to the gates connected to the corresponding pixels in all columns and rows after some clock cycles. After the display data bits of the page reach the gates connected to corresponding pixels, the display data bits may be written into the memory of the pixels in a scan period, and may be used to switch on or off the drive currents for all pixels at the same time to turn on or off each pixel during an emission period for the page. The drive currents for all pixels may be about the same, and thus the intensities of the light emitted by the pixels that are turned on may be about the same at a given time. Each image frame may include multiple pages. While display data bits for a page are stored in the memory of the pixels and are used to switch on or off the drive currents, display data bits for the next page may be sent to the gates connected to the pixels in the manner described above. The display data bits for the next page may then be written into the memory of the pixels in a scan period, and may be used to switch on or off the driver currents for all pixels at the same time to turn on or off each pixel during an emission period for the next page. The amount of light emitted by each pixel in an image frame may be the sum of the light emission by the pixel for all pages (e.g., subframes) of the image frame.

In one example, a display drive circuit may include a plurality of lines of cells (or pixels). Each line of cells of the plurality of lines of cell may include a plurality of pixel drive circuits for a plurality of light emitters (e.g., LEDs, OLEDs, micro-LEDs, μOLEDs, etc.), and a data line including an array of data bit storage devices connected serially and configured to shift display data bits along the data line. An output of each data bit storage device of the array of data bit storage devices may be connected to a corresponding pixel drive circuit of the plurality of pixel drive circuits, for example, through a switch. Each pixel drive circuit of the plurality of pixel drive circuits may include, for example, a digital memory cell electrically connected to an output of a corresponding data bit storage device and configured to store a display data bit from the output of the data bit storage device, and a switch controlled by the display data bit stored in the digital memory cell to turn on or off a drive current to a respective light emitter of the plurality of light emitters.

In one example, a display drive circuit may include a plurality of lines of cells. Each cell of a line of cells of the plurality of lines of cells may include: a data bit storage device (e.g., a gate, latch, or digital buffer); a digital memory cell (e.g., an SRAM cell) electrically coupled (e.g., through a switch) to an output of the data bit storage device and configured to store a display data bit from the output of the data bit storage device; and a switch (e.g., a transistor) controlled by the display data bit stored in the digital memory cell to turn on or off a drive current for a light emitter. Data bit storage devices of the line of cells may be serially connected to form a data line that is capable of shifting display data bits along the data line.

In another example, a display panel may include a plurality of lines of cells. A line of cells of the plurality of lines of cells may include a plurality of light emitters; a plurality of pixel drive circuits for the plurality of light emitters, and a data line including an array of data bit storage devices connected serially to shift display data bits along the data line. Each pixel drive circuit of the plurality of pixel drive circuits may be coupled to a respective light emitter of the plurality of light emitters. An output of each data bit storage device of the array of data bit storage devices may be connected to a corresponding pixel drive circuit of the plurality of pixel drive circuits.

The digital driving display system disclosed herein is different from the conventional passive matrix (PM) and active matrix (AM) display, and is referred to herein as digital matrix (DM) display, to distinguish PM and AM displays. The technique of embedding digital circuit in each pixel may be used in emissive displays such as OLED or LED displays, and may also be used in reflective displays such as digital micromirror devices (DMDs). Compared with analog active matrix displays, the digital matrix displays disclosed herein may not use analog drivers and large capacitors for storing analog data, may not use analog circuits such as digital-to-analog converter (DAC) and analog buffers, and may not use the column and gate lines to drive (write data and turn on) the pixels row-by-row. Therefore, the digital matrix display disclosed herein may reduce power consumption, circuit area, and cost, and may improve the display resolution and uniformity.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of a near-eye display system according to certain embodiments.

FIG. 5 illustrates an example of waveguide display-based near-eye display system.

FIG. 6 illustrates an example of an image source assembly in an augmented reality system according to certain embodiments.

FIG. 7 is a simplified block diagram of an example of a display system according to certain embodiments.

FIG. 8 is a simplified block diagram illustrating an example of a display system according to certain embodiments.

FIG. 9A illustrates an example of a light source controlled by analog driving signals.

FIG. 9B illustrates an example of a light source controlled by digital driving data.

FIGS. 10A and 10B illustrate operations of an example of an analog active matrix display.

FIG. 11A illustrates operations of an example of an analog driving display.

FIG. 11B illustrates operations of an example of a digital driving display.

FIG. 12A illustrates an example of a pulse-width modulation digital driving method.

FIG. 12B illustrates an example of a binary-coded digital driving method.

FIG. 12C illustrates an example of a subframe digital driving method.

FIG. 13A illustrates an example of a digital matrix display with data drivers at a peripheral region according to certain embodiments.

FIG. 13B illustrates an example of a digital matrix display with data drivers in the digital matrix device according to certain embodiments.

FIG. 14 illustrates operations of an example of a digital matrix display according to certain embodiments.

FIG. 15 illustrates an example of a cell of an example of a digital matrix display in a scan period according to certain embodiments.

FIG. 16 illustrates operations of cells in a column or row of cells of an example of a digital matrix display according to certain embodiments.

FIG. 17A illustrates an example of a data line in a digital matrix display according to certain embodiments.

FIG. 17B includes an example of a timing diagram illustrating pixel data load and scan and light emission for a page (or subframe) of an image frame in an example of a digital matrix display according to certain embodiments.

FIG. 18 illustrates examples of operations of transmission gates on a data line of an example of a digital matrix display in a page writing period (or emission period) according to certain embodiments.

FIG. 19A includes a timing diagram of an image frame including multiple subframes for an example of an active matrix display.

FIG. 19B includes a timing diagram of an image frame including multiple subframes for an example of a digital matrix display disclosed herein according to certain embodiments.

FIG. 20 illustrates an example of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to display systems. More specifically, and without limitation, techniques disclosed herein relate to digital driving displays. Various inventive embodiments are described herein, including devices, systems, circuits, structures, methods, processes, and the like.

Augmented reality (AR) and virtual reality (VR) applications may use near-eye displays (e.g., head-mounted displays) to present images to users. A near-eye display system may include an image source (e.g., a display panel) for generating image frames, and display optics for projecting the image frames to the user's eyes. It is generally desirable that the near-eye display system has a large field of view and a higher resolution in order to, for example, improve the immersive experience of using the near-eye display system. The field of view of a display system may be proportional to the size of the image source (e.g., the display panel). To achieve a high resolution, micro-displays with ultra-high pixels per inch (PPI) may be needed. There may be many technological challenges and cost issues associated with making high-PPI display panels (e.g., silicon-based OLED panels, micro-LED panels, or other display panels) with large sizes to cover wider field of view.

Many conventional display systems use active matrix displays that may include a row driver (e.g., gate driver) and a column driver (e.g., data driver or source driver) on sides of a display panel. In analog active matrix displays, analog driving may be used to control the amount of light with different intensities for a given time. An active matrix display may be driven row-by-row. The pixels in active matrix displays share the gate driver and the column driver. The gate driver may enable pixels one row at a time. The data driver in an analog active matrix display may receive digital video data, convert the digital video data to analog video data (e.g., voltage or current signals) using digital-to-analog converters (DACs), distribute the analog video data to the pixels on the enabled row using column data lines, and then distribute video data to the pixels on the next enabled row. Therefore, pixels on a same row receive corresponding video data simultaneously. The pixels may hold the data during the display frame time using, for example, capacitors. The DACs may need to convert thousands of data for each row time, and thus may need a large area and have large power consumption and high cost. The charging time is another issue, due to the parasitic resistance and capacitance along with the data line. A buffer may need to be used to charge and discharge a data line and the storage capacitor in the pixel, in order to deliver the desired analog voltage levels to the storage capacitor through the data line. These thousands of high-speed analog buffers may increase the area, power, and cost of the active matrix device. Therefore, active matrix displays used in micro-display applications (e.g., near-eye displays) may have large power consumption and limited circuit area for each pixel. A large portion of the power consumption of an analog active matrix display may be consumed by the analog driving circuits, such as the DACs that convert digital display data to voltage/current signals, and analog buffers that deliver voltage/current signals to the pixels through long data lines. It is desirable that a micro-display panel has a small size for low cost and high speed, and has a high resolution for image quality, which may lead to a small pixel size and a limited area of the drive circuitry for each pixel. Advanced pixel circuits may enable large-size and high-resolution panels with thin film transistor (TFT) backplanes, but TFT backplanes may have issues such as slow speed, nonuniformity, and instability.

A digital driving display may use a similar active matrix, but the video data to drive the pixels may be digital (“on” or “off”), where the digital driving may control the amount of light by controlling the emission time of a light source having a constant light intensity. The digital driving may avoid analog circuits, such as the DACs, analog buffers, and large storage capacitors. Moreover, digital data charging time differs from analog charging time. While analog charging may need a long time to reach the desired voltage level, digital charging may need a shorter time to meet the input tolerance. Therefore, digital displays with memory in each pixel may be a promising solution for next generation displays with high resolution (e.g., above 4K) with lower power consumption. Digital driving on TFT planes was unsuccessful due to the backplane limitations such as instability, nonuniformity, and low speed of TFTs backplanes. CMOS on the silicon backplane may be used in micro-displays for AR VR applications, such that high speed driving may be achieved for high resolution and there may not be the need for threshold voltage compensation for each transistor.

According to certain embodiments, a fully digital driving micro-display and the operations of the digital driving micro-display are disclosed. In the digital driving micro-display disclosed herein, pixels in a row or a column may be connected to a data line, where the data line may include serially connected gates for latching and sending digital data bits for pages (e.g., subframes) of an image frame to the pixels. For each page of the image frame, a display data bit may be sent from a data driver to a gate connected to a first pixel in each row or column in one clock cycle, and the gate may, in the next clock cycle, send the received display data bit to the gate connected to the next pixel in the row or column, and also receive a new display data bit from the data driver. In this way, display data bits of a page may be shifted to the gates connected to the corresponding pixels in all columns and rows after some clock cycles. After the display data bits of the page reach the gates connected to corresponding pixels, the display data bits may be written into the memory of the pixels in a scan period, and may be used to switch on or off the drive currents for all pixels at the same time to turn on or off each pixel during an emission period for the page. The drive currents for all pixels may be about the same, and thus the intensities of the light emitted by the pixels that are turned on may be about the same at a given time. Each image frame may include multiple pages. While display data bits for a page are stored in the memory of the pixels and are used to switch on or off the drive currents, display data bits for the next page may be sent to the gates connected to the pixels in the manner described above. The display data bits for the next page may then be written into the memory of the pixels in a scan period, and may be used to switch on or off the driver currents for all pixels at the same time to turn on or off each pixel during an emission period for the next page. The amount of light emitted by each pixel in an image frame may be the sum of the light emission by the pixel for all pages (e.g., subframes) of the image frame.

In one example, a display drive circuit may include a plurality of lines of cells (or pixels). Each line of cells of the plurality of lines of cell may include a plurality of pixel drive circuits for a plurality of light emitters (e.g., LEDs, OLEDs, micro-LEDs, OLEDs, etc.), and a data line including an array of data bit storage devices connected serially and configured to shift display data bits along the data line. An output of each data bit storage device of the array of data bit storage devices may be connected to a corresponding pixel drive circuit of the plurality of pixel drive circuits, for example, through a switch. Each pixel drive circuit of the plurality of pixel drive circuits may include, for example, a digital memory cell electrically connected to an output of a corresponding data bit storage device and configured to store a display data bit from the output of the data bit storage device, and a switch controlled by the display data bit stored in the digital memory cell to turn on or off a drive current to a respective light emitter of the plurality of light emitters.

In one example, a display drive circuit may include a plurality of lines of cells. Each cell of a line of cells of the plurality of lines of cells may include: a data bit storage device (e.g., a gate, latch, or digital buffer); a digital memory cell (e.g., an SRAM cell) electrically coupled (e.g., through a switch) to an output of the data bit storage device and configured to store a display data bit from the output of the data bit storage device; and a switch (e.g., a transistor) controlled by the display data bit stored in the digital memory cell to turn on or off a drive current for a light emitter. Data bit storage devices of the line of cells may be serially connected to form a data line that is capable of shifting display data bits along the data line.

In another example, a display panel may include a plurality of lines of cells. A line of cells of the plurality of lines of cells may include a plurality of light emitters; a plurality of pixel drive circuits for the plurality of light emitters, and a data line including an array of data bit storage devices connected serially to shift display data bits along the data line. Each pixel drive circuit of the plurality of pixel drive circuits may be coupled to a respective light emitter of the plurality of light emitters. An output of each data bit storage device of the array of data bit storage devices may be connected to a corresponding pixel drive circuit of the plurality of pixel drive circuits.

The digital driving display system disclosed herein is different from the conventional passive matrix (PM) and active matrix (AM) display, and is referred to herein as digital matrix (DM) display, to distinguish PM and AM displays. The technique of embedding digital circuit in each pixel may be used in emissive displays such as OLED or LED displays, and may also be used in reflective displays such as digital micromirror devices (DMDs). Compared with analog active matrix displays, the digital matrix displays disclosed herein may not use analog drivers and large capacitors for storing analog data, may not use analog circuits such as digital-to-analog converter (DAC) and analog buffers, and may not use the column and gate lines to drive (write data and turn on) the pixels row-by-row. Therefore, the digital matrix display disclosed herein may reduce power consumption, circuit area, and cost, and may improve the display resolution and uniformity.

The digital driving displays described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

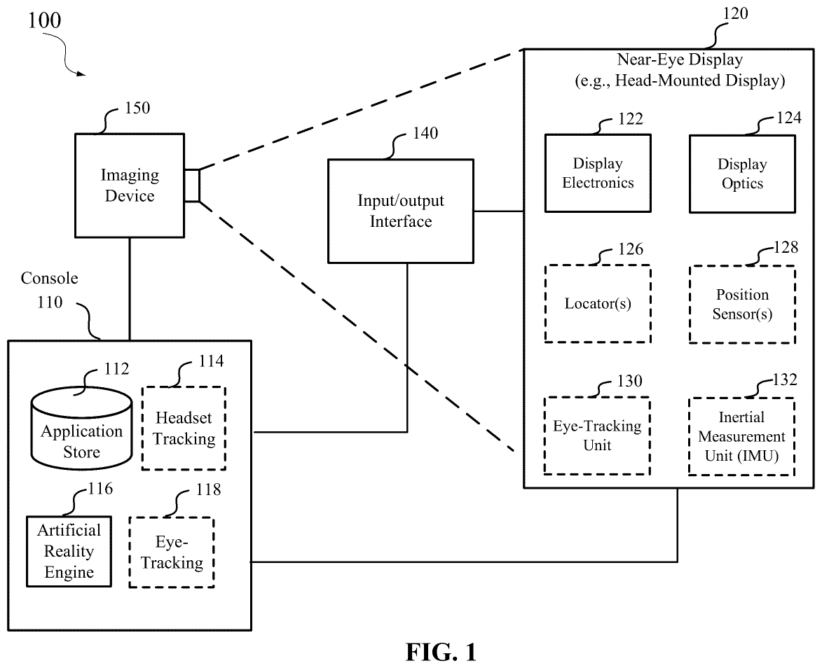

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

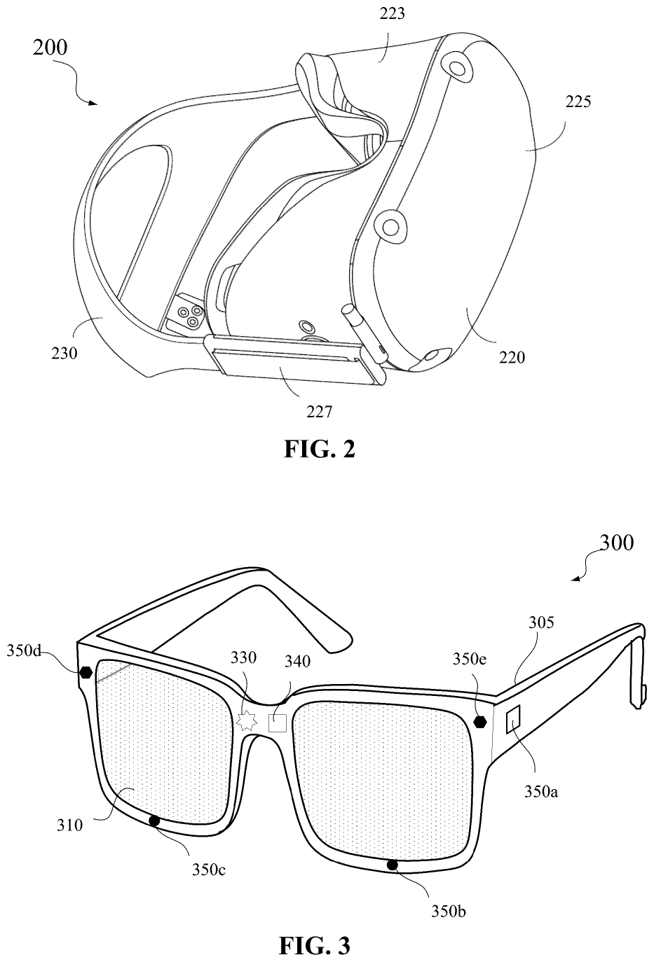

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (LED or micro-LED) display, an active matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a RLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

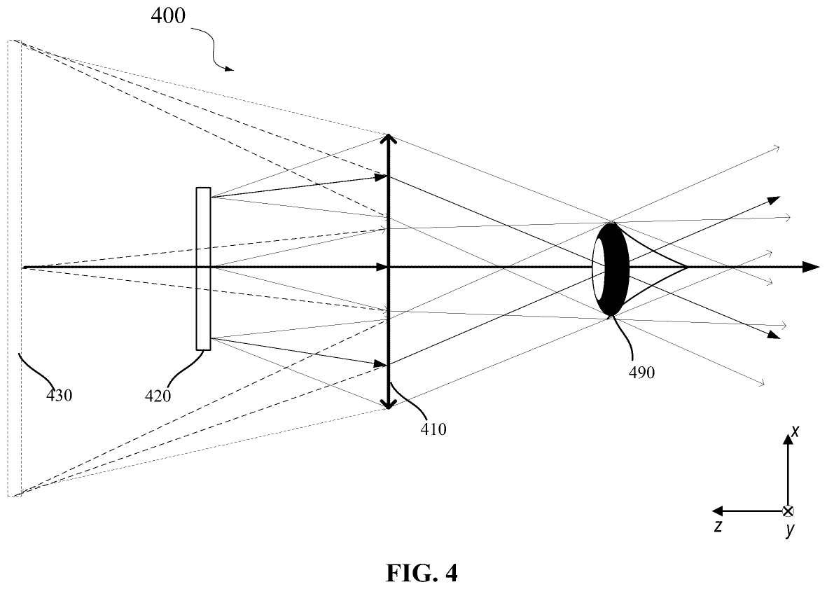

FIG. 4 illustrates an example of a near-eye display device 400 according to certain embodiments. Near-eye display device 400 may include an image source 420 (e.g., a display panel) and optional display optics 410. FIG. 4 shows that image source 420 is in front of display optics 410. In some other embodiments, image source 420 may be located outside of the field of view of the user's eye 490. For example, one or more deflectors or directional couplers may be used to deflect light from an image source to make the image source appear to be at the location of image source 420 shown in FIG. 4. Image source 420 may include a two-dimensional array of light emitters, such as semiconductor micro-LEDs or micro-OLEDs. The dimensions and pitches of the light emitters in image source 420 may be small. For example, each light emitter may have a diameter less than 2 μm (e.g., about 1.2 μm) and the pitch may be less than 2 μm (e.g., about 1.5 μm). As such, the number of light emitters in image source 420 can be equal to or greater than the number of pixels in a display image, such as 960×720, 1280×720, 1440×1080, 1920×1080, 2160×1080, 2560×1080, or more pixels. Thus, a display image may be generated simultaneously by image source 420.

Light from an area (e.g., a pixel or a light emitter) of image source 420 may be directed to a user's eye 490 by display optics 410. Light directed by display optics 410 may form virtual images on an image plane 430. The location of image plane 430 may be determined based on the location of image source 420 and the focal length of display optics 410. A user's eye 490 may form a real image on the retina of user's eye 490 using light directed by display optics 410. In this way, objects at different spatial locations on image source 420 may appear to be objects on an image plane far away from user's eye 490 at different viewing angles.

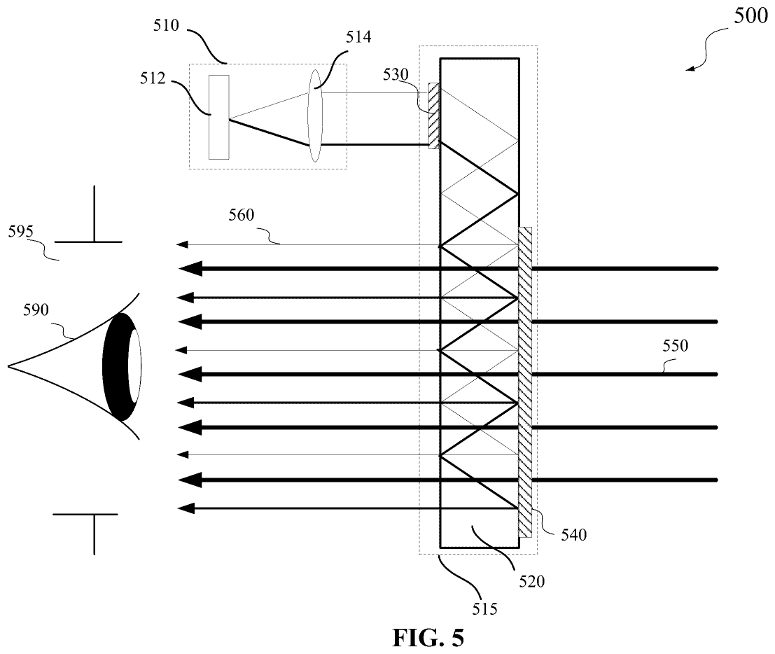

FIG. 5 illustrates an example of a waveguide display-based near-eye display system 500 according to certain embodiments. Near-eye display system 500 may include a projector 510 and a combiner 515. Projector 510 may include a light source or image source 512 and projector optics 514. In some embodiments, light source or image source 512 may include one or more micro-LED devices described above. In some embodiments, image source 512 may include a plurality of pixels that displays virtual objects, such as an LCD display panel or an LED display panel. In some embodiments, image source 512 may include a light source that generates coherent or partially coherent light. For example, image source 512 may include a laser diode, a vertical cavity surface emitting laser, an LED, and/or a micro-LED described above. In some embodiments, image source 512 may include a plurality of light sources (e.g., an array of micro-LEDs described above), each emitting a monochromatic image light corresponding to a primary color (e.g., red, green, or blue). In some embodiments, image source 512 may include three two-dimensional arrays of micro-LEDs, where each two-dimensional array of micro-LEDs may include micro-LEDs configured to emit light of a primary color (e.g., red, green, or blue). In some embodiments, image source 512 may include an optical pattern generator, such as a spatial light modulator. Projector optics 514 may include one or more optical components that can condition the light from image source 512, such as expanding, collimating, scanning, or projecting light from image source 512 to combiner 515. The one or more optical components may include, for example, one or more lenses, liquid lenses, mirrors, apertures, and/or gratings. For example, in some embodiments, image source 512 may include one or more one-dimensional arrays or elongated two-dimensional arrays of micro-LEDs, and projector optics 514 may include one or more one-dimensional scanners (e.g., micro-mirrors or prisms) configured to scan the one-dimensional arrays or elongated two-dimensional arrays of micro-LEDs to generate image frames. In some embodiments, projector optics 514 may include a liquid lens (e.g., a liquid crystal lens) with a plurality of electrodes that allows scanning of the light from image source 512.

Combiner 515 may include an input coupler 530 for coupling light from projector 510 into a substrate 520 of combiner 515. Combiner 515 may transmit at least 50% of light in a first wavelength range and reflect at least 25% of light in a second wavelength range. For example, the first wavelength range may be visible light from about 500 nm to about 650 nm, and the second wavelength range may be in the infrared band, for example, from about 800 nm to about 1200 nm. Input coupler 530 may include a volume holographic grating, a diffractive optical element (DOE) (e.g., a surface-relief grating), a slanted surface of substrate 520, or a refractive coupler (e.g., a wedge or a prism). For example, input coupler 530 may include a reflective volume Bragg grating or a transmissive volume Bragg grating. Input coupler 530 may have a coupling efficiency of greater than 30%, 50%, 75%, 90%, or higher for visible light. Light coupled into substrate 520 may propagate within substrate 520 through, for example, total internal reflection (TIR). Substrate 520 may be in the form of a lens of a pair of eyeglasses. Substrate 520 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 12 mm or more. Substrate 520 may be transparent to visible light.

Substrate 520 may include or may be coupled to a plurality of output couplers 540, each configured to extract at least a portion of the light guided by and propagating within substrate 520 from substrate 520, and direct extracted light 560 to an eyebox 595 where an eye 590 of the user of near-eye display system 500 may be located when near-eye display system 500 is in use. The plurality of output couplers 540 may replicate the exit pupil to increase the size of eyebox 595 such that the displayed image is visible in a larger area. As input coupler 530, output couplers 540 may include grating couplers (e.g., volume holographic gratings or surface-relief gratings), other diffraction optical elements, prisms, etc. For example, output couplers 540 may include reflective volume Bragg gratings or transmissive volume Bragg gratings. Output couplers 540 may have different coupling (e.g., diffraction) efficiencies at different locations. Substrate 520 may also allow light 550 from the environment in front of combiner 515 to pass through with little or no loss. Output couplers 540 may also allow light 550 to pass through with little loss. For example, in some implementations, output couplers 540 may have a very low diffraction efficiency for light 550 such that light 550 may be refracted or otherwise pass through output couplers 540 with little loss, and thus may have a higher intensity than extracted light 560. In some implementations, output couplers 540 may have a high diffraction efficiency for light 550 and may diffract light 550 in certain desired directions (i.e., diffraction angles) with little loss. As a result, the user may be able to view combined images of the environment in front of combiner 515 and images of virtual objects projected by projector 510.

In some embodiments, projector 510, input coupler 530, and output coupler 540 may be on any side of substrate 520. Input coupler 530 and output coupler 540 may be reflective gratings (also referred to as reflective gratings) or transmissive gratings (also referred to as transmissive gratings) to couple display light into or out of substrate 520.

FIG. 5 shows that the exit pupil may be replicated by output couplers 540 to form an aggregated exit pupil or eyebox, where different regions in a field of view (e.g., different pixels on image source 512) may be associated with different respective propagation directions towards the eyebox, and light from a same field of view (e.g., a same pixel on image source 512) may have a same propagation direction for the different individual exit pupils. Thus, a single image of image source 512 may be formed by the user's eye located anywhere in the eyebox, where light from different individual exit pupils and propagating in the same direction may be from a same pixel on image source 512 and may be focused onto a same location on the retina of the user's eye. In other words, the user's eye may convert angular information in the eyebox or exit pupil (e.g., corresponding to a Fourier plane) to spatial information in images form on the retina. FIG. 5 shows that the image of the image source is visible by the user's eye even if the user's eye moves to different locations in the eyebox.

The display panels or image sources described above (e.g., image source 420 or 512) may be implemented using, for example, a liquid crystal display (LCD), an organic light emitting diode (OLED) display, a micro-OLED display, an inorganic light emitting diode (ILED) display, a micro-light emitting diode (micro-LED) display, an active matrix OLED display (AMOLED), a transparent OLED display (TOLED), or some other displays. A display panel may include light sources described above and drive circuits for driving the light sources.

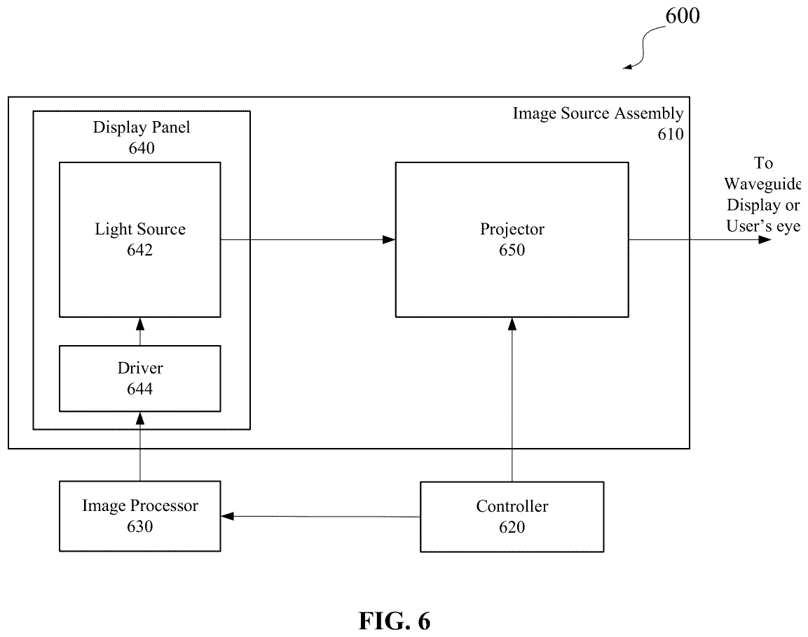

FIG. 6 illustrates an example of an image source assembly 610 in a near-eye display system 600 according to certain embodiments. Image source assembly 610 may include, for example, a display panel 640 that may generate display images to be projected to the user's eyes, and a projector 650 that may project the display images generated by display panel 640 to a waveguide display as described above with respect to FIGS. 4 and 5. Display panel 640 may include a light source 642 and a drive circuit 644 for light source 642. Light source 642 may include, for example, image source 420 or 512. Projector 650 may include, for example, a freeform optical element, a scanning mirror, and/or projection optics described above. Near-eye display system 600 may also include a controller 620 that synchronously controls light source 642 and projector 650. Image source assembly 610 may generate and output image light to a waveguide display or user's eyes. As described above, the waveguide display may receive the image light at one or more input-coupling elements, and guide the received image light to one or more output-coupling elements. The input and output coupling elements may include, for example, a diffraction grating, a holographic grating, a prism, or any combination thereof. The input-coupling element may be chosen such that total internal reflection occurs with the waveguide display. The output-coupling element may couple portions of the total internally reflected image light out of the waveguide display.

As described above, light source 642 may include a plurality of light emitters arranged in an array or a matrix. Each light emitter may emit monochromatic light, such as red light, blue light, green light, infra-red light, and the like. While RGB colors are often discussed in this disclosure, embodiments described herein are not limited to using red, green, and blue as primary colors. Other colors can also be used as the primary colors of near-eye display system 600. In some embodiments, a display panel in accordance with an embodiment may use more than three primary colors. Each pixel in light source 642 may include three subpixels that include a red micro-LED, a green micro-LED, and a blue micro-LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer. The multiple layers of semiconductor materials may be grown on a surface of a substrate having a certain orientation. In some embodiments, to increase light extraction efficiency, a mesa that includes at least some of the layers of semiconductor materials may be formed.

Controller 620 may control the image rendering operations of image source assembly 610, such as the operations of light source 642 and/or projector 650. For example, controller 620 may determine instructions for image source assembly 610 to render one or more display images. The instructions may include display instructions and scanning instructions. In some embodiments, the display instructions may include an image file (e.g., a bitmap file). The display instructions may be received from, for example, a console, such as console 110 described above with respect to FIG. 1. The scanning instructions may be used by image source assembly 610 to generate image light. The scanning instructions may specify, for example, a type of a source of image light (e.g., monochromatic or polychromatic), a scanning rate, an orientation of a scanning apparatus, one or more illumination parameters, or any combination thereof. Controller 620 may include a combination of hardware, software, and/or firmware not shown here so as not to obscure other aspects of the present disclosure.

In some embodiments, controller 620 may be a graphics processing unit (GPU) of a display device. In other embodiments, controller 620 may be other kinds of processors. The operations performed by controller 620 may include taking content for display and dividing the content into discrete sections. Controller 620 may provide to light source 642 scanning instructions that include an address corresponding to an individual source element of light source 642 and/or an electrical bias applied to the individual source element. Controller 620 may instruct light source 642 to sequentially present the discrete sections using light emitters corresponding to one or more rows of pixels in an image ultimately displayed to the user. Controller 620 may also instruct projector 650 to perform different adjustments of the light. For example, controller 620 may control projector 650 to scan the discrete sections to different areas of a coupling element of the waveguide display. As such, at the exit pupil of the waveguide display, each discrete portion is presented in a different respective location. While each discrete section is presented at a different respective time, the presentation and scanning of the discrete sections occur fast enough such that a user's eye may integrate the different sections into a single image or series of images.

Image processor 630 may be a general-purpose processor and/or one or more application-specific circuits that are dedicated to performing the features described herein. In one embodiment, a general-purpose processor may be coupled to a memory to execute software instructions that cause the processor to perform certain processes described herein. In another embodiment, image processor 630 may be one or more circuits that are dedicated to performing certain features. While image processor 630 in FIG. 6 is shown as a stand-alone unit that is separate from controller 620 and drive circuit 644, image processor 630 may be a sub-unit of controller 620 or drive circuit 644 in other embodiments. In other words, in those embodiments, controller 620 or drive circuit 644 may perform various image processing functions of image processor 630. Image processor 630 may also be referred to as an image processing circuit.

In the example shown in FIG. 6, light source 642 may be driven by drive circuit 644, based on data or instructions (e.g., display and scanning instructions) sent from controller 620 or image processor 630. In one embodiment, drive circuit 644 may include a circuit panel that connects to and mechanically holds various light emitters of light source 642. Light source 642 may emit light in accordance with one or more illumination parameters that are set by the controller 620 and potentially adjusted by image processor 630 and drive circuit 644. An illumination parameter may be used by light source 642 to generate light. An illumination parameter may include, for example, source wavelength, pulse rate, pulse amplitude, beam type (continuous or pulsed), other parameter(s) that may affect the emitted light, or any combination thereof. In some embodiments, the source light generated by light source 642 may include multiple beams of red light, green light, and blue light, or any combination thereof.

Projector 650 may perform a set of optical functions, such as focusing, combining, conditioning, or scanning the image light generated by light source 642. In some embodiments, projector 650 may include a combining assembly, a light conditioning assembly, or a scanning mirror assembly. Projector 650 may include one or more optical components that optically adjust and potentially re-direct the light from light source 642. One example of the adjustment of light may include conditioning the light, such as expanding, collimating, correcting for one or more optical errors (e.g., field curvature, chromatic aberration, etc.), some other adjustments of the light, or any combination thereof. The optical components of projector 650 may include, for example, lenses, mirrors, apertures, gratings, or any combination thereof.

Projector 650 may redirect image light via its one or more reflective and/or refractive portions so that the image light is projected at certain orientations toward the waveguide display. The location where the image light is redirected toward the waveguide display may depend on specific orientations of the one or more reflective and/or refractive portions. In some embodiments, projector 650 includes a single scanning mirror that scans in at least two dimensions. In other embodiments, projector 650 may include a plurality of scanning mirrors that each scan in directions orthogonal to each other. Projector 650 may perform a raster scan (horizontally or vertically), a bi-resonant scan, or any combination thereof. In some embodiments, projector 650 may perform a controlled vibration along the horizontal and/or vertical directions with a specific frequency of oscillation to scan along two dimensions and generate a two-dimensional projected image of the media presented to user's eyes. In other embodiments, projector 650 may include a lens or prism that may serve similar or the same function as one or more scanning mirrors. In some embodiments, image source assembly 610 may not include a projector, where the light emitted by light source 642 may be directly incident on the waveguide display.

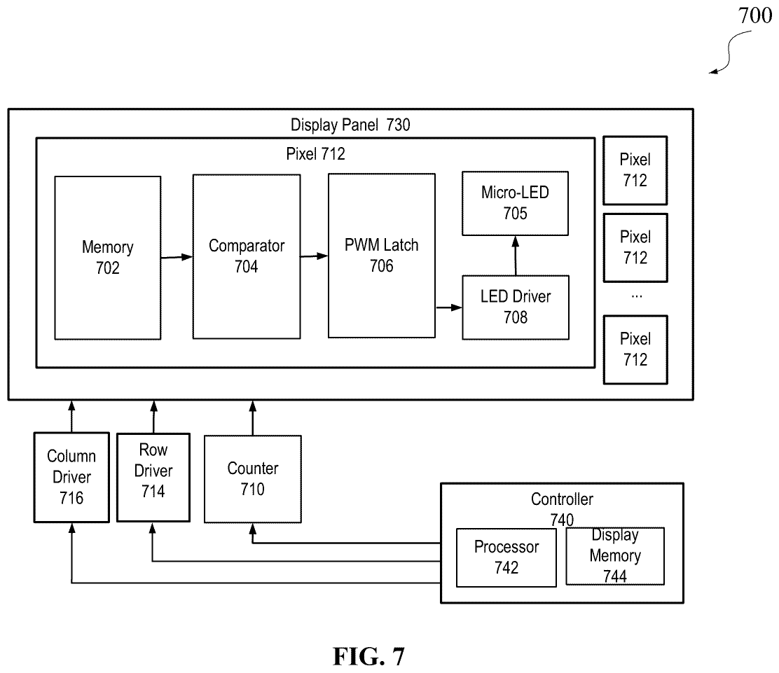

FIG. 7 is a simplified block diagram of an example of a display device 700 according to certain embodiments. Display device 700 may include a display panel 730 that includes an array (e.g., a 2-D array) of pixels 712. Display panel 730 may be an example of display panel 640. FIG. 7 illustrates the block diagram of one pixel 712, which may be similar to other pixels 712 in the array of pixels. Pixels 712 may be an example of light source 642 and part of drive circuit 644. The various functional components of each pixel 712 may generate digital PWM signals using digital comparison to control a micro-LED. Pixel 712 may include a micro-LED 705, which may emit light at an intensity level that is controlled by the PWM signals. The circuits that control micro-LED 705 in pixel 712 may be an example of a portion of drive circuits 644 and may include a memory device 702, a comparator 704, a PWM latch circuit 706, and a LED driver circuit 708. Memory device 702 may be a part of pixel 712 or may be outside of pixel 712. Memory device 702 may include, for example, SRAM cells, and may store the intensity data for pixel 712. Memory device 702 may be connected to comparator 704, which may be connected to PWM latch circuit 706. PWM latch circuit 706 may be connected to LED driver circuit 708 to control LED driver circuit 708 to provide a pulse width modulation to a drive current that may be an approximately constant current. LED driver circuit 708 may drive micro-LED 705 with the drive current for different periods of time based on the PWM signals to emit different amounts of light during a PWM frame (also referred to as a PWM cycle). In general, the longer micro-LED 705 is driven at the current level within a PWM cycle, the brighter micro-LED 705 may be perceived by an observer.

Display device 700 may also include a row driver 714, a column driver 716, and a counter 710. In some embodiments, row driver 714, column driver 716, and counter 710 may be parts of the periphery circuits of display panel 730. Row driver 714 and column driver 716 may be connected to pixels 712. For example, row driver 714 may be connected to memory device 702, comparator 704, and PWM latch circuit 706. Column driver 716 may be connected to memory device 1102. Display device 700 may further include a controller 740, which may include a processor 742 and a display memory device 744. Controller 740 may be connected to row driver 714 and column driver 716 to control the operations of row driver 714 and column driver 716. For example, processor 742 of controller 740 may provide control signals to row driver 714 and column driver 716 to operate pixels 712. Counter 710 may be coupled to display memory device 744, which may store, for example, calibration data and/or a gamma correction look-up table (LUT).

Memory device 702 may include digital data storage cells, such as cells of SRAM or some other types of memory. For example, memory device 702 may include multiple memory cells for storing the display data (e.g., intensity data) for pixel 712. Each cell in memory device 702 may be connected to row driver 714 via a word line (WL) and may be connected to column driver 716 via a bit line (BL) and an inverse bit line (BL). Memory device 702 may receive WL signals from row driver 714 for memory word selection, and may receive, from column driver 716, control words in the form of data bits for writing to the selected memory cells. The bit values of data bits D define the intensity level of the pixel for a PWM frame. The number of data bits (or bit-cells) in a control word may vary. In one example, each control word in memory device 702 may include 3 bit-cells storing a 3-bit value representing one of eight levels of brightness (e.g., 000, 001, 010, 011, 100, 101, 70, and 71). In another example, each control word in the memory device 702 may include 8 bit-cells storing an 8-bit value representing one of 256 levels of brightness.

Counter 710 may be used to generate counter values (e.g., a clock cycle count) based on a clock signal. The counter value of counter 710 may be compared with the value of a control word from memory device 702 by comparator 704 to generate a comparison result. For example, the comparison result may be generated based on the exclusive OR (XOR) of each data bit in the control word and the corresponding bit of the counter value. Comparator 704 may include a dynamic comparison node that switches between a high and low level according to the comparison results, and may output the comparison results to PWM latch circuit 706 to generate PWM signals. Alternatively, comparator 704 may include a statically driven comparison node that switches between a high and low level according to the comparison results, and may output the comparison results to PWM latch circuit 706 to generate PWM signals.

LED driver circuit 708 may include one or more LED drive transistors. One of the one or more LED drive transistors may have a source or drain terminal connected to micro-LED 705. One of the one or more LED drive transistors may include a gate terminal connected to PWM latch circuit 706 to receive the PWM signal for modulating the current flowing through the source and drain terminals of the driving transistor into micro-LED 705.

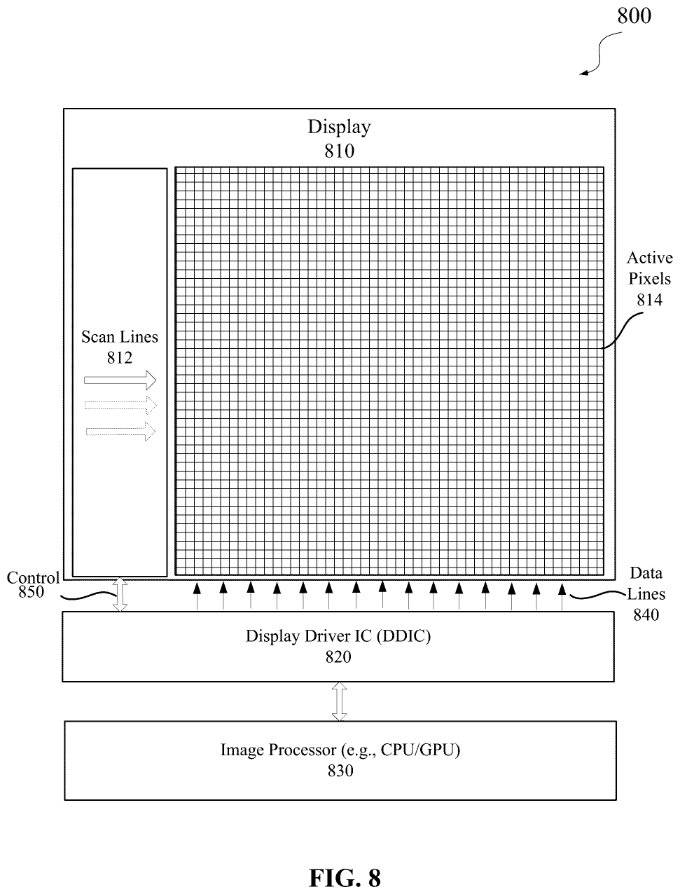

FIG. 8 is a simplified block diagram illustrating an example of a display system 800 including a display 810 according to certain embodiments. Display 810 may be any display panel described above, such as an OLED array or a micro-LED array. Display 810 may include active pixels 814 that are arranged in a two-dimensional pixel array. Each active pixel 814 may include three (red, green, and blue) light sources, such as AMOLEDs or micro-LEDs. Each active pixel 814 may also include a driving and compensation circuit for each light source. The driving and compensation circuit may receive and store image data for the active pixel and provide a drive current to the light source for light emission.

The two-dimensional pixel array of active pixels 814 may be coupled to a plurality of scan lines 812 and a plurality of data lines 840 directly or indirectly. Each scan line 812 may be coupled to active pixels 814 on a row of the two-dimensional pixel array and may be used to connect active pixels 814 on a row of the two-dimensional pixel array to corresponding data lines 840. Each data line 840 may be coupled to active pixels 814 on a column of the two-dimensional pixel array through switches controlled by scan lines 812. Each data line 840 may be used to send image data to the active pixel 814 coupled to a scan line 812 that has been selected or activated. In general, the plurality of scan lines may be selected or activated one at a time to sequentially connect the active pixels coupled to the scan lines to corresponding data lines. The plurality of data lines 840 may be driven in parallel to send data to a row of active pixels 814 connected to a selected or activated scan line 812 at the same time.

Display 810 may also include some on-panel peripheral circuits, such an array of gates used to drive different scan lines for selecting pixels on the scan lines to receive image data for displaying. The peripheral circuits may be connected to a control bus 850, which may send control signal(s) to selectively activate (scan) the plurality of scan lines for receiving image data and turning on the light sources for light emission.

Data lines 840 and control bus 850 may be driven by a display driver IC (DDIC) 820. DDIC 820 may receive image data from an image processor 830 and send the received image data to active pixels 814 through data lines 840. In some implementations, DDIC 820 may not include a buffer. In some implementations, DDIC 820 may include a frame buffer, and thus may temporarily store the received image data and process the image data before sending the image data to data lines 840. For example, in some implementations, DDIC 820 may perform scrambling, distortion, correction, or other transformation of the image data. DDIC 820 may also generate scan control signals, such as clocks and various trigger signals, and send the scan control signals to display 810 through scan control bus 850.

Image processor 830 may include one or more CPUs or GPUs. Image processor 830 may receive information such as position information, acceleration information, velocity information, predicted future positions, or some combination thereof (e.g., from various sensors), and execute graphic processing applications (e.g., a game) to render image frames using the received information.

Light emission displays such as organic light-emitting diode (OLED) and light-emitting diode (LED) displays may display images represented by the amount of light emitted. Current consumer displays generally use the analog driving method, where the data driver may receive digital video data, convert the digital video data into analog video data (voltage or current signals) using DACs, distribute the analog video data to the pixels on a selected row using column data lines. The pixels may hold the analog video data during the display frame time using, for example, capacitors. During the emission time period, the analog video data may control a current drive transistor to provide the desired drive current to the light source (e.g., OLED or LED).

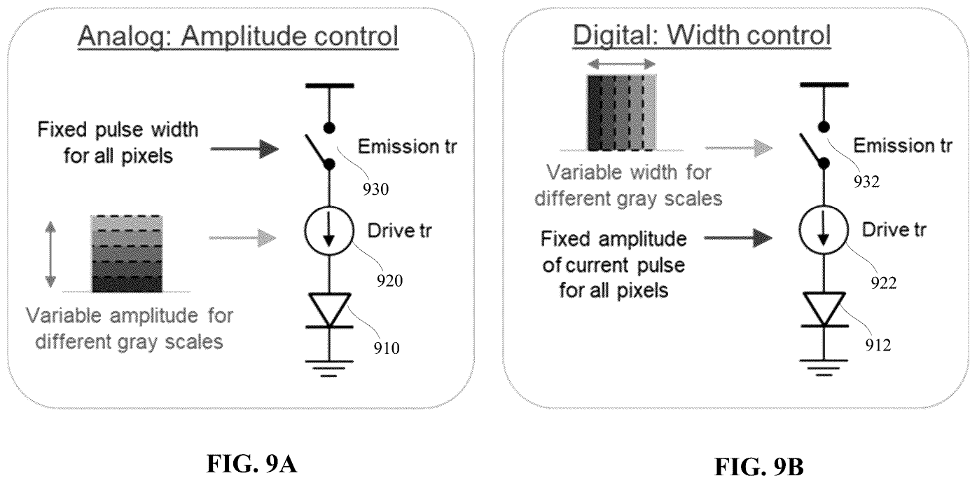

FIG. 9A illustrates an example of a light source 910 controlled by analog driving signals. As shown in FIG. 9A, an analog driving scheme may control the amount of emitted light by controlling the intensity of the emitted light in an emission time period, for example, by applying control signals of different amplitudes to a current driver 920 (e.g., a current drive transistor), such that the drive currents and thus light emission intensities may be different in the emission time period that is controlled using pulses. As described above, analog control signals of different amplitudes may be generated by a DAC based on digital video data, and may be sent to a storage capacitor of the pixel by an analog buffer through a data line.

In contrast, in digital driving displays, the video data to drive the pixels in a display panel may be digital (“on” or “off”), where the amount of light emitted by each pixel in each image frame may be controlled by controlling the emission time of a light source emitting light of a constant amplitude or intensity. The emission time may be controlled based on the digital video data for the pixel that may be stored to a memory device for the pixel.

FIG. 9B illustrates an example of a light source 912 controlled by digital driving data. As shown in FIG. 9B, a digital driving scheme may control the amount of light using different time durations while the amplitude or intensity of the emitted light may be constant. In the illustrated example, pulses of a constant amplitude may be applied to a current driver 922 to generate a constant drive current, but the drive current may be turned on for different time periods by switching an emission transistor 932 based on the digital video data stored in the memory for the pixel.

The analog driving method as shown in FIG. 9A has been dominant for decades. Advanced pixel circuits may allow for large-size and high-resolution display panels with thin film transistor (TFT) backplanes. But the analog driving method may need analog devices such as DACs, analog buffers, and capacitors. The DACs may need to convert thousands of data values in each row time, and thus may need a large area and have large power consumption and high cost. An analog buffer may need to be used to charge and discharge a data line and the storage capacitor in the pixel, and may need to deliver the desired analog voltage level to the storage capacitor through the data line. These thousands of high-speed analog buffers may increase the area, power, and cost of the analog active matrix display device. Therefore, analog active matrix displays used in micro-display applications (e.g., near-eye displays) may have large power consumption and limited circuit area for each pixel. A large portion of the power consumption of an analog active matrix display may be consumed by the analog driving circuits, such as the DACs that convert digital display data to voltage/current signals, and the analog buffers that deliver voltage/current signals. But digital driving was not successful due to, for example, the slow speed and nonuniformity of the TFT backplanes.

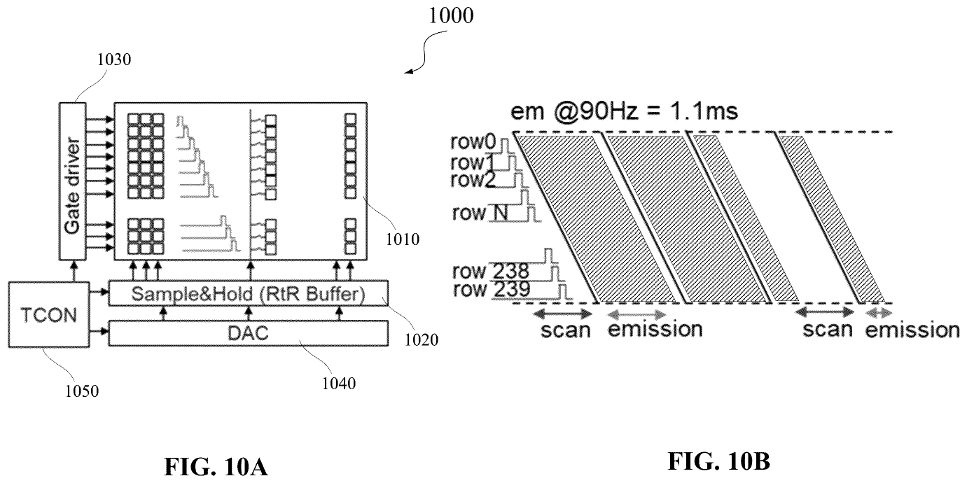

FIGS. 10A and 10B illustrate operations of an example of an analog active matrix display 1000. Analog active matrix display 1000 shown in FIG. 10A may include an active matrix 1010, a gate driver 1030 (e.g., row driver), and a data driver (e.g., column driver or source driver) that may include an array of DACs 1040 and sample and hold circuits 1020 (which may include analog buffers) outside of active matrix 1010. Gate driver 1030, DACs 1040, and sample and hold circuits 1020 may be controlled by time control circuits 1050. Gate driver 1030 may enable pixels one row at a time. The data driver may receive digital video data, convert the digital video data to analog voltage or current signals using DACs 1040, and send the analog video data to the pixels on the enabled row using column data lines. The analog video data may control a current driver for the light source of the pixel to drive the light source with the desired drive current to emit light with the desired intensity during an emission time period.

As shown in FIG. 10B, the rows of pixels may be selected sequentially, such as one row at a time, to receive data (in a scan period) and emit light (in an emission period). Thus, different rows of pixels may not receive data at the same time, and may not emit light at the same time. But pixels on a same row may receive data at the same time, and may emit light at the same time. The scan time generally includes the reset time, in-pixel threshold voltage (Vth) compensation time, and data charging time. The scan time for each row may be determined by the frame rate and resolution. For example, for a 3K panel at a 90 Hz frame rate, the time for each row may be about 3700 ns. For a 4K panel at a 90 Hz frame rate, the time for each row may be about 2800 ns. But the charging time may need to be between, for example, about 500 ns to about 1000 ns. Therefore, higher resolution, such as 5K and 6K resolution, may be difficult to achieve.

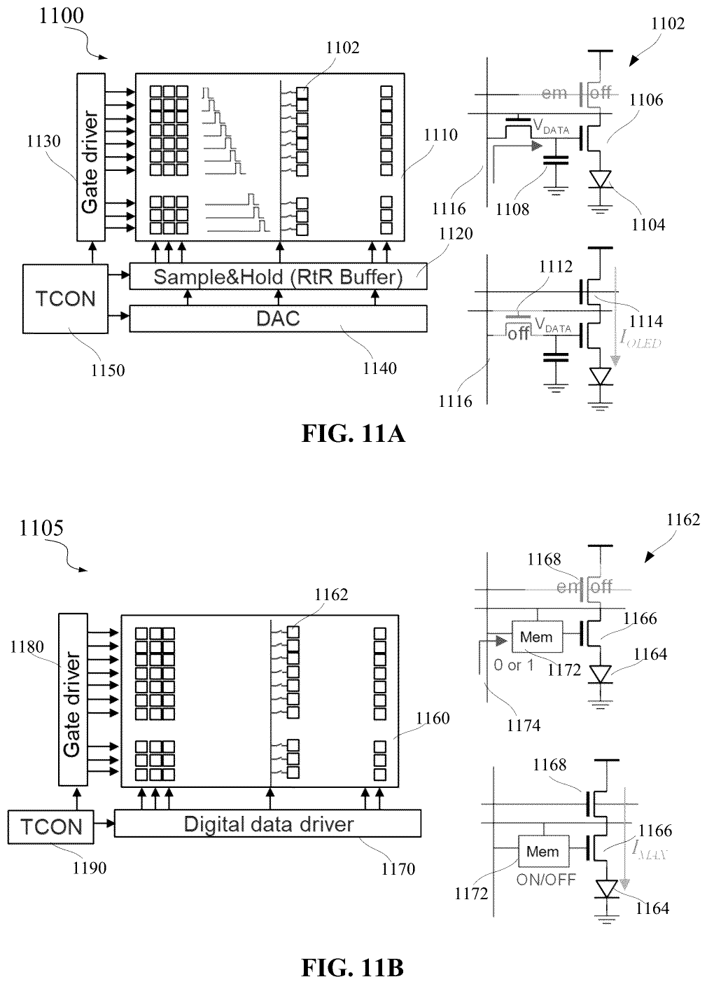

FIG. 11A illustrates operations of an example of an analog driving display 1100. Analog driving display 1100 shown in FIG. 11A may include an active matrix 1110, a gate driver 1130 (e.g., row driver), and a data driver (e.g., column driver or source driver) that may include an array of DACs 1140 and sample and hold circuits 1120 (which may include analog buffers) outside of active matrix 1110. Gate driver 1130, DACs 1140, and sample and hold circuits 1120 may be controlled by time control circuits 1150. Active matrix 1110 may include a two-dimensional array of pixels 1102. Each pixel 1102 may include a light source 1104 (e.g., an LED or OLED), a current drive transistor 1106, a capacitor 1108, a transmission gate 1112, and a switch transistor 1114. Pixels 1102 in a same column may be connected to a column data line 1116.

As shown in FIG. 11A, gate driver 1030 may turn on the transmission gates 1112 for pixels on a row at a time. The data driver may receive digital video data, convert the digital video data to an analog voltage or current signal using a DAC 1140, and send the analog video data to capacitor 1108 of the pixel through a column data line 1116 and transmission gates 1112. The analog video data may be stored in capacitor 1108 in the scan period, during which period switch transistor 1114 may be switched off, such that no current may pass through light source 1104. In the emission period, transmission gates 1112 may be turn off to stop receiving data from column data line 1116, and switch transistor 1114 may be turned on. The analog video data stored in capacitor 1108 may control current drive transistor 1106 to drive light source 1104 with the desired drive current (e.g., I_{OLED}) from the supply to emit light with the desired intensity during an emission time period. DACs 1140 may need to convert thousands of data in each row time, and buffers may be needed to charge and discharge column data lines 1116, as well as capacitor 1108 in the pixel. The buffer needs to deliver the analog voltage to the storage capacitor through the line. These thousands of high-speed analog buffers and DACs may cause issues related to circuit area, power, and cost as described above.

FIG. 11B illustrates operations of an example of a digital driving display 1105. Digital driving display 1105 may include a pixel array 1160 (e.g., an active matrix), a gate driver 1180 (e.g., row driver), and a data driver 1170 (e.g., column driver or source driver) outside of pixel array 1160. Gate driver 1180 and data driver 1170 may be controlled by time control circuits 1190. Pixel array 1160 may include a two-dimensional array of pixels 1162. Each pixel 1162 may include a light source 1164 (e.g., an LED or OLED), a current drive transistor 1166, a switch transistor 1168, and a memory cell 1172. Pixels 1162 in a same column may be connected to a data line 1174.

As shown in FIG. 11B, gate driver 1180 may also be used to select pixels on a row at a time by selectively connecting memory cells 1172 of pixels on a row to corresponding data lines 1174. Data driver 1170 may receive digital video data and send the digital video data to memory cells 1172 of the corresponding pixels in the row through data lines 1174. The digital video data may be stored in memory cells 1172 in the scan period, during which period switch transistor 1168 may be switched off, such that no current may pass through light source 1164. In the emission period, memory cells 1172 may be disconnected from corresponding data lines 1174, and switch transistors 1168 may be turned on. The digital video data stored in memory cells 1172 may turn on current drive transistor 1166 to drive light source 1164 with a constant drive current (e.g., I_{MAX}) for a period of time (e.g., corresponding to the digital video data) during the emission period. As in analog driving display 1100, pixels in different rows of digital driving display 1105 may receive data at different time in a rolling manner (e.g., one row at a time) and may also emit light at different time in each frame or subframe.

As shown by FIGS. 11A and 11B, digital driving may avoid some of the issues of analog driving circuits described above. The DAC is not used in digital driving. The analog buffer is not used in digital driving neither. The memory cells replace the storage capacitors in pixels, where the capacitance of the memory cells may be smaller than that of the storage capacitors. Moreover, digital data charging time differs from analog charging time. While analog charging may need a long time to reach the desired voltage level, digital charging may on a shorter time to meet the input tolerance. Therefore, digital displays with memory in each pixel may be a promising solution for next generation displays with high resolution (e.g., above 4K) with lower power consumption. Digital driving on TFT planes was unsuccessful due to the backplane limitations such as instability, nonuniformity, and low speed of TFTs backplanes. CMOS on the silicon backplane may be used in micro-displays for AR VR applications, such that high speed driving may be achieved for high resolution and there may not be the need for threshold voltage compensation for each transistor.

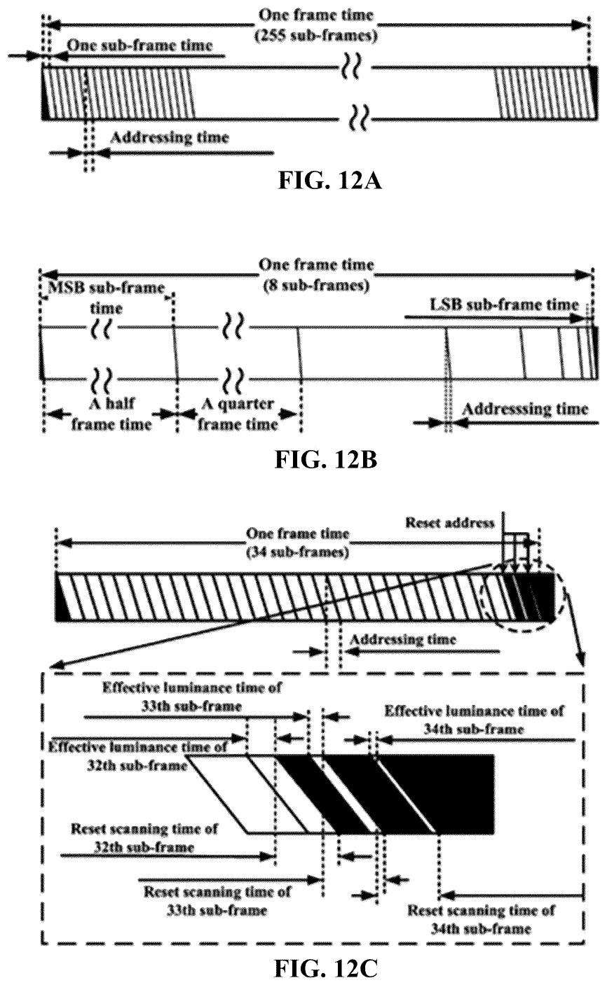

FIGS. 12A-12C illustrates examples of digital driving schemes, such as pulse-width modulation, binary-coded modulation, and subframe driving methods. The digital driving method may involve controlling the width of light emission, which may be referred to as the pulse width modulation (PWM) method. The basic PWM method is to change the duty of the on/off ratio of the pulse signal.

FIG. 12A illustrates an example of a pulse-width modulation digital driving method. In the example illustrated in FIG. 12A, 8-bit grayscale may be achieved by dividing each image frame into 256 subframes, where the light source may emit light in between 0 and 256 subframes to emit light in one of 256 levels. For example, the light source of a pixel that needs to display a digital image value 10 may be turned on during 10 subframes of the 256 subframes. Because each frame is equally divided into subframes, where the number of subframes is equal to the number of desired intensity level, high-frequency signals may need to be used for high resolution and high color depth.

FIG. 12B illustrates an example of a binary-coded digital driving method. In the binary coded digital driving method shown in FIG. 12B, binary-coded modulation may utilize weighted time duration for each bit. For example, the MSB of the image data for a pixel may be used to control the emission of the light source in the pixel in a first subframe that has a length about a half of the frame time, where a “1” in the MSB may turn on the light source in the first subframe, whereas a “0” in the MSB may turn off the light source in the first subframe. Similarly, the second MSB of the image data for a pixel may be used to control the emission of the light source in the pixel in a second subframe that has a length about a quarter of the frame time, where a “1” in the second MSB may turn on the light source in the second subframe, whereas a “0” in the MSB may turn off the light source in the second subframe. The LSB of 8-bit image data for a pixel may be used to control the emission of the light source in the pixel in an eighth subframe that has a length about a 256th of the frame time, where a “1” in the LSB may turn on the light source in the eighth subframe, whereas a “0” in the LSB may turn off the light source in the eighth subframe. As such, the highest operation frequency may be determined by the length of the subframe for the LSB, and thus may be about the same as the highest operation frequency of the PWM driving method shown in FIG. 12B.

As shown above, digital display with memory in the pixel is a good substitute for the conventional analog driving methods. By removing the capacitors in pixels and changing the analog signal switches to digital transistors, the driving load of the data buffer can be reduced. But in digital displays that use column data lines as shown in FIG. 11B and digital driving schemes as shown in FIGS. 12A-12B, there are still time constraints from the buffer to data delivery, especially in high-resolution displays.

FIG. 12C illustrates an example of a subframe digital driving method. The subframe digital driving method shown in FIG. 12C utilizes the same subframe length. The MSBs may be implemented using subframes having the same length, and the LSBs may be implemented using duty cycle control to reduce the emission time. For example, 8-bit image data can be divided into 5 MSBs that can be implemented using subframes having the same time length (such as 16, 8, 4, 2, and 1 subframes for bit 7, 6, 5, 4, and 3, respectively), and 3 LSBs that can be implemented using smaller duty cycles such as ½, ¼, and ⅛ of a subframe in three subframes. The duty cycle may be controlled using, for example, emission control signals. Therefore, 34 (16+8+4+2+1+3) subframes may be used to achieve 255 gray levels with fewer visual artifacts. In some implementations, the 8-bit data may be divided and implemented differently, such as using 19 subframes that include 15 (8+4+2+1) subframes for the 4 MSBs and 4 subframes for the 4 LSBs (using ½, ¼, ⅛, and 1/16 of a subframe, respectively). In this way, the highest operating frequency (e.g., subframe rate) of the digital driving may be significantly reduced.

According to certain embodiments, in order to further reduce power consumption, circuit area, and cost, and improve the display resolution and uniformity of micro-displays, a fully digital driving micro-display and the operations of the digital driving micro-display are disclosed. In the digital driving micro-display disclosed herein, pixels in a row or a column may be connected to a data line, where the data line may include serially connected gates for latching and sending digital data bits for pages (e.g., subframes) of an image frame to the pixels. For each page of the image frame, a display data bit may be sent from a data driver to a gate connected to a first pixel in each row or column in one clock cycle, and the gate may, in the next clock cycle, send the received display data bit to the gate connected to the next pixel in the row or column, and also receive a new display data bit from the data driver. In this way, display data bits of a page may be shifted to the gates connected to the corresponding pixels in all columns and rows after some clock cycles. After the display data bits of the page reach the gates connected to corresponding pixels, the display data bits may be written into the memory of the pixels in a scan period, and may be used to switch on or off the drive currents for all pixels at the same time to turn on or off each pixel during an emission period for the page. The drive currents for all pixels may be about the same, and thus the intensities of the light emitted by the pixels that are turned on may be about the same at a given time. Each image frame may include multiple pages. While display data bits for a page are stored in the memory of the pixels and are used to switch on or off the drive currents, display data bits for the next page may be sent to the gates connected to the pixels in the manner described above. The display data bits for the next page may then be written into the memory of the pixels in a scan period, and may be used to switch on or off the driver currents for all pixels at the same time to turn on or off each pixel during an emission period for the next page. The amount of light emitted by each pixel in an image frame may be the sum of the light emission by the pixel for all pages (e.g., subframes) of the image frame.

In one example, a display drive circuit may include a plurality of lines of cells (or pixels). Each line of cells of the plurality of lines of cell may include a plurality of pixel drive circuits for a plurality of light emitters (e.g., LEDs, OLEDs, micro-LEDs, μOLEDs, etc.), and a data line including an array of data bit storage devices connected serially and configured to shift display data bits along the data line. An output of each data bit storage device of the array of data bit storage devices may be connected to a corresponding pixel drive circuit of the plurality of pixel drive circuits, for example, through a switch. Each pixel drive circuit of the plurality of pixel drive circuits may include, for example, a digital memory cell electrically connected to an output of a corresponding data bit storage device and configured to store a display data bit from the output of the data bit storage device, and a switch controlled by the display data bit stored in the digital memory cell to turn on or off a drive current to a respective light emitter of the plurality of light emitters.

In one example, a display drive circuit may include a plurality of lines of cells. Each cell of a line of cells of the plurality of lines of cells may include: a data bit storage device (e.g., a gate, latch, or digital buffer); a digital memory cell (e.g., an SRAM cell) electrically coupled (e.g., through a switch) to an output of the data bit storage device and configured to store a display data bit from the output of the data bit storage device; and a switch (e.g., a transistor) controlled by the display data bit stored in the digital memory cell to turn on or off a drive current for a light emitter. Data bit storage devices of the line of cells may be serially connected to form a data line that is capable of shifting display data bits along the data line.

In another example, a display panel may include a plurality of lines of cells. A line of cells of the plurality of lines of cells may include a plurality of light emitters; a plurality of pixel drive circuits for the plurality of light emitters, and a data line including an array of data bit storage devices connected serially to shift display data bits along the data line. Each pixel drive circuit of the plurality of pixel drive circuits may be coupled to a respective light emitter of the plurality of light emitters. An output of each data bit storage device of the array of data bit storage devices may be connected to a corresponding pixel drive circuit of the plurality of pixel drive circuits.

The digital driving display system disclosed herein is different from the conventional passive matrix (PM) and active matrix (AM) display, and is referred to herein as digital matrix (DM) display, to distinguish PM and AM displays. The technique of embedding digital circuit in each pixel may be used in emissive displays such as OLED or LED displays, and may also be used in reflective displays such as digital micromirror devices (DMDs). Compared with analog active matrix displays, the digital matrix displays disclosed herein may not use analog drivers and large capacitors for storing analog data, may not use analog circuits such as digital-to-analog converter (DAC) and analog buffers, and may not use the column and gate lines to drive (write data and turn on) the pixels row-by-row. Therefore, the digital matrix display disclosed herein may reduce power consumption, circuit area, and cost, and may improve the display resolution and uniformity.

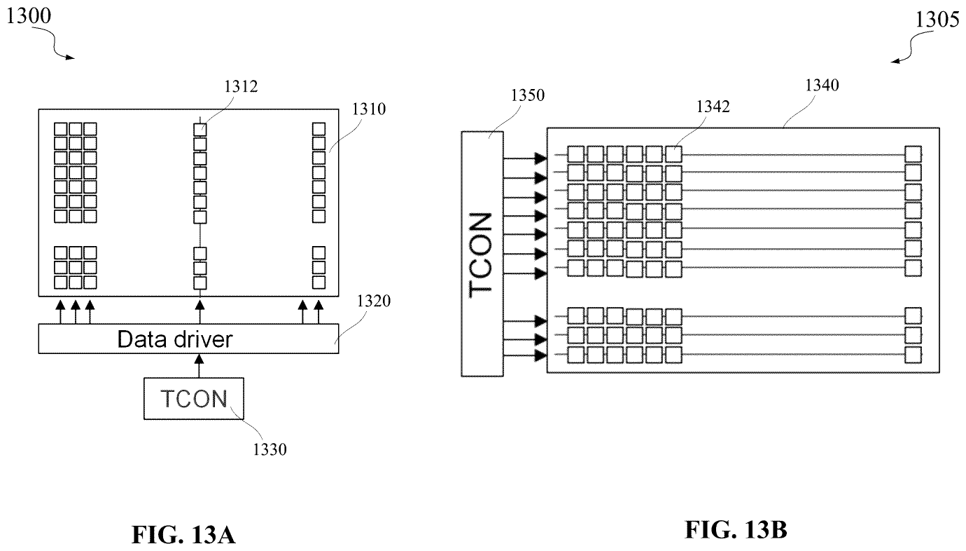

FIG. 13A illustrates an example of a digital matrix display 1300 with data drivers 1320 at peripheral regions according to certain embodiments. In the illustrated example, digital matrix display 1300 includes a digital matrix 1310 that includes a two-dimensional array of cells 1312. Each cell 1312 may include a corresponding gate (or a register, latch, flip-flop, and the like) for data shifting, digital memory for storing display data bits, and a pixel (including drive transistor and a light emitter such as an LED or OLED) as described in more detail below. The gates of cells in a column (or row) of digital matrix 1310 may be serially connected to form a data line that includes a gate array. Data drivers 1320 (e.g., DDICs) may be on a separate device (e.g., chip or die) outside of digital matrix 1310, and may be controlled by time control circuits 1330 to shift data into cells 1312.

FIG. 13B illustrates an example of a digital matrix display 1305 with data drivers in the digital matrix device according to certain embodiments. Digital matrix display 1305 may include a digital matrix 1340 and time control circuits 1350. Digital matrix 1340 may include a two-dimensional array of cells 1342 and on-chip data driving integrated circuits (DDICs). Each cells 1342 may include a corresponding gate (or a register, latch, flip-flop, and the like) for data shifting, digital memory for storing display data bits, and a pixel (including drive transistor and a light emitter such as an LED or OLED) as described in more detail below. The gates of cells in a row (or column) of digital matrix 1340 may be serially connected to form a data line that includes a gate array. When the data driver is on the same chip as the two-dimensional array of cells, load for the data driver may be lower and the data transfer from the data driver to the cells may be faster.

The operations of digital matrix 1310 or 1340 and cells 1312 or 1342 of digital matrix display 1300 or 1305 differ from active matrix displays, such as digital driving display 1105 shown in FIG. 11B. For example, an active matrix display may include row and column drivers to activate row by row. In contrast, DM displays may not use row drivers (or gate driver). The data driver in a DM displays delivers display data for a subframe to the first cell, the first cell passes the data to the next, and so on. After one subframe period (e.g., after 4 K clocks for a 4K panel), each cell of the digital matric display may have its designated data at the gate (or register, latch, or flip-flop) of the cell. Then the digital data for the subframe (e.g., stored at the gates of the cells) may be written to the memory in all cells of the digital matrix in a same scan cycle. All pixels may then be switched on or off in a same emission period based on the digital data in the subframe. During the emission period, data for the next subframe may be shifted into the gate arrays. In this way, the digital matrix may display an image frame by displaying one page (e.g., subframe) after another page. This digital driving scheme allows data to be written to all pixels simultaneously and all pixels to emit light simultaneously, where the page writing can be done in the emission period.

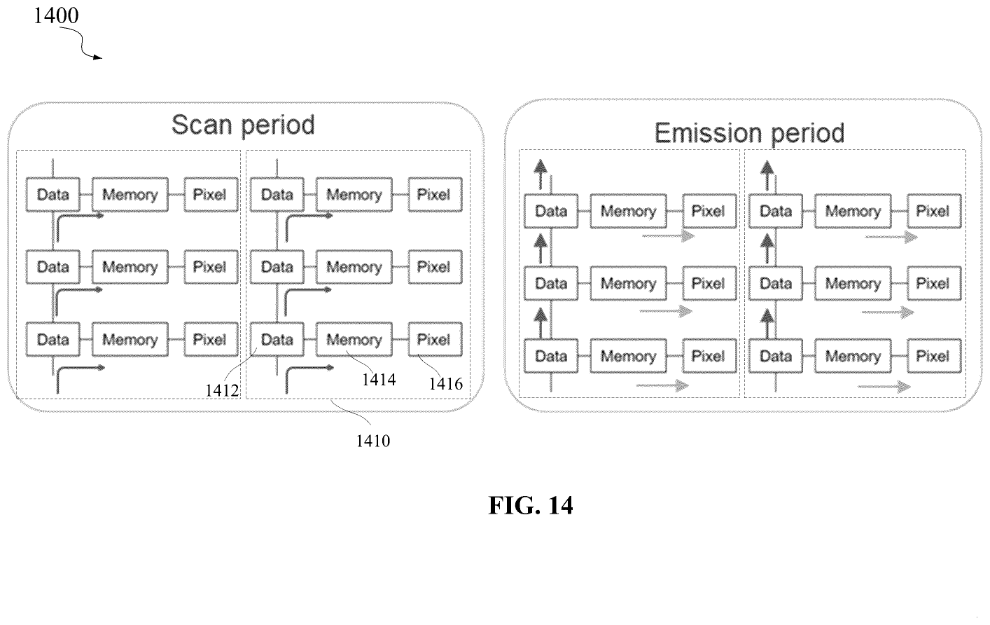

FIG. 14 illustrates examples of operations of an example of a digital matrix display 1400 according to certain embodiments. In the illustrated example, digital matrix display 1400 includes a plurality of columns of cells 1410. Each column of cells 1410 may include a plurality of cells. Each cell may include a gate 1412 (e.g., a digital buffer, an inverter or NOT gate, a latch, a flip-flop, a register, etc.) that may store and shift digital display data, a memory cell 1414 that can store the pixel data for a subframe during the emission period, and a pixel 1416 that includes a current driving circuit that is controlled by the pixel data stored in memory cell 1414 to provide a drive current to a light emitter during the emission period.

The left diagram in FIG. 14 shows the operations of digital matrix display 1400 in a scan period after display data for a subframe has been shifted into the arrays of gates 1412. The subframe data for all pixels can be sent to and stored in the corresponding memory cells 1414 in the same scan period (e.g., one clock cycle). The right diagram in FIG. 14 shows the operations of digital matrix display 1400 in an emission period after a scan period. The subframe data for all pixels stored in the corresponding memory cells 1414 may control the current drive circuits in the corresponding pixels simultaneously during the emission time period. In addition, during the emission period, gates 1412 are disconnected from the corresponding memory cells, and may sequentially shift in data for the next subframe as indicated by the vertical arrows.

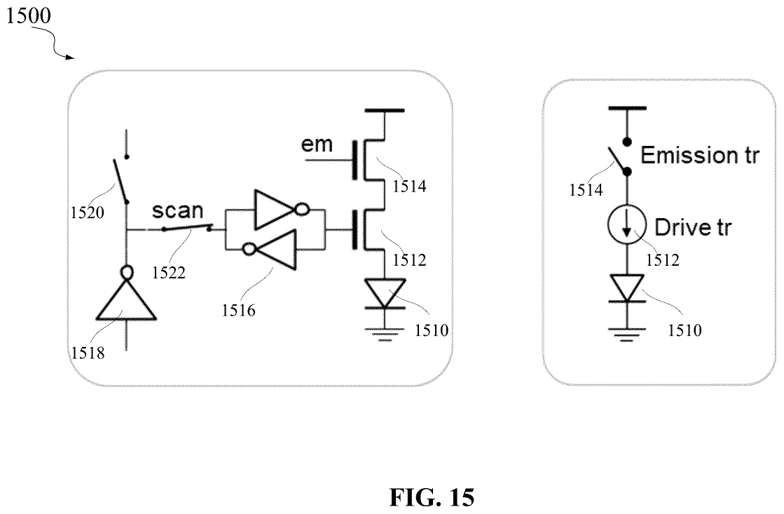

FIG. 15 illustrates an example of a cell 1500 of an example of a digital matrix display (e.g., micro-LED or μOLED display) in a scan period according to certain embodiments. Cell 1500 may be an example of cells 1312 of FIG. 13A, cells 1342 of FIG. 13B, or cells of FIG. 14. In the illustrated example, cell 1500 of the DM display may include a gate array part, a memory cell 1516, and a driving part. The gate array part may be part of a gate array for a column of cells, and may include, for example, a gate 1518 (e.g., an inverter or a NOT gate) and a switch 1520. Switch 1520 may be selectively turned on or off during the page writing period (and emission period) and may be turned off during the scan period. A scan switch 1522 may connect the gate array part to memory cell 1516, which may include, for example, a static random access memory (SRAM) cell (e.g., including two inverters cross-connected back-to-back to form a latch for data holding as shown in FIG. 15). Scan switch 1522 may be turned on during the scan period to latch data at the output of gate 1518 to memory cell 1516, and may be turned off during other time (e.g., page writing or emission period). The driving part may include a drive transistor 1512, an emission control transistor 1514, and a light emitter 1510, such as an LED or OLED. The output of memory cell 1516 may be connected (directly or indirectly through a switch) to drive transistor 1512, and may, depending on the data (e.g., “1” or “0”) stored in memory cell 1516, turn on or off drive transistor 1512 and thus the drive current from a source to light emitter 1510 through emission control transistor 1514. Emission control transistor 1514 may be connected serially with drive transistor 1512, and may be turned off to turn off the light emitter during the scan periods, and/or control the duty cycle of the emission (e.g., in the subframe driving method shown in FIG. 12C) during the emission periods.

The digital driving circuit may not need a reset transistor that is used in analog driving display to connect to the anode of the light emitter (an LED or OLED) and the ground (or another constant voltage level) for writing precise voltage levels into the storage capacitor. Scan switches 1522 may operate in a same manner across the cells. Emission control transistors 1514 may also operate in a same manner across the cells. In some embodiments, an emission control transistor 1514 may be shared by adjacent pixels. In embodiments where the panel system allows electroluminescent VDD (ELVDD) signal swing, the emission control signal can be omitted, which means that all pixels in the panel can share the same emission control transistor.

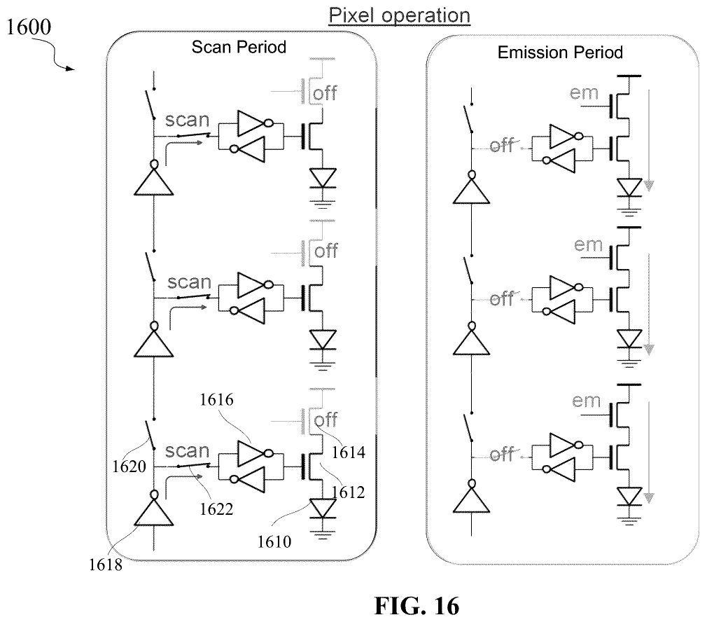

FIG. 16 illustrates operations of cells in a column or row of cells of an example of a digital matrix display 1600 according to certain embodiments. Each cell in digital matrix display 1600 may be similar to cell 1500. For example, each cell in digital matrix display 1600 may include a gate 1618 (e.g., an inverter or NOT gate), a switch 1620, a scan switch 1622, a memory cell 1616 (e.g., including an SRAM cell), an emission control transistor 1614 (or a switch), a drive transistor 1612, and a light emitter (e.g., an LED or OLED).

The left diagram in FIG. 16 shows the operations of digital matrix display 1600 in a scan period after display data for a subframe has been shifted into the arrays of gates 1618. Scan switches 1622 for all cells may be turned on at the same time in the scan period, such that the subframe data for all pixels can be sent to and stored in the corresponding memory cells 1616 in the same scan period (e.g., one clock cycle). During the scan period, emission control transistors 1614 may be turned off such that no current may be supplied from a supply to light emitters 1610 through drive transistor 1612.

The right diagram in FIG. 16 shows the operations of digital matrix display 1600 in an emission period (which may also be a page writing period) after a scan period. In the emission period, scan switches 1622 may be turned off, and emission control transistors 1614 may be turned on. The subframe data for all pixels stored in the corresponding memory cells 1616 may, based on the stored data (e.g., “1” or “0”), turn on or off the drive transistors 1612 in the corresponding pixels during the emission period for the subframe. In addition, during the emission period, gates 1412 are disconnected from the corresponding memory cells, and switch 1620 may be turned on or off by a control signal (e.g., a clock signal) to sequentially shift in data for the next subframe in a plurality of clock cycles. Other cells in DM display 1600 may be similar to the three cells shown in FIG. 16 and may operate in similar manner.

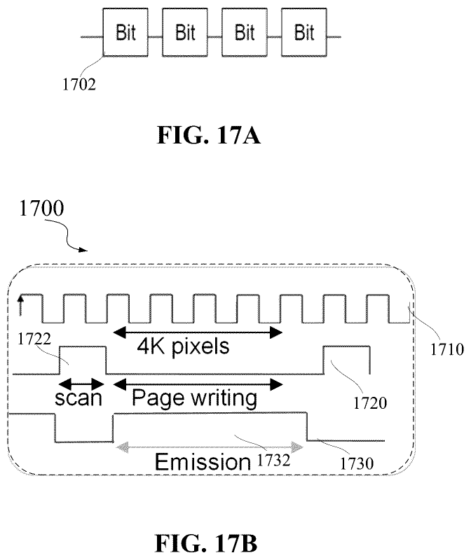

FIG. 17A illustrates an example of a data line in a digital matrix display according to certain embodiments. The data line may include an array of gates 1702 connected through switches (not shown). The array of gates may be connected serially. The connection can be in the vertical or horizontal direction. Each gate may store one bit of data. In one clock cycle (or half clock cycle or multiple cycles), the data bit may be shifted in a one-pixel step. The data for a subframe or page may be loaded bit-by-bit until the first data bit is shifted through the array of gates to the gate for the last pixel.

FIG. 17B includes an example of a timing diagram 1700 illustrating pixel data load and scan and light emission for a page (e.g., subframe) of an image frame in an example of a digital matrix display according to certain embodiments. A waveform 1710 in timing diagram 1700 shows a clock signal, a waveform 1720 in timing diagram 1700 shows a scan switch control signal, and a waveform 1730 in timing diagram 1700 shows an emission control signal. As illustrated, when the scan switch control signal is high (e.g., for a clock cycle), the digital matrix display may be in a scan period 1722, where the gate for each pixel may be connected to the memory cell for the pixel to store data in the memory cell. When the scan switch control signal is high, the emission control signal may be low to turn off the emission control transistors (e.g., emission control transistors 1514 or 1614). After the scan period 1722, the scan switch control signal may be set to low and the emission control signal may be set to high in an emission period 1732. Therefore, the gate may be disconnected from the corresponding memory cell, whereas the data stored in the memory cell may turn on the drive transistor of the pixel if the data stored in the memory cell is, for example, “1”. As such, a drive current may flow from a power source, through the emission control transistor and the drive transistor, to the light emitter of the pixel to turn on the light emitter as described above with respect to, for example, FIGS. 15 and 16.

In emission period 1732, the scan switch control signal may be set to low, such that the gate may be disconnected from the corresponding memory cell. Therefore, the gates may be controlled to shift in data for the next page (e.g., subframe) in emission period 1732. In one example, emission period 1732 may include a number of clock cycles that is about the same as the number of cells in a gate array (e.g., the number of cells in a column or row). In each clock cycle, the data bits in the gate array may be shifted one step (e.g., one bit) towards an end of the gate array. After a number of clock cycles (e.g., about the number of gates in the gate array or the number of cells in a column or row), the first data bit may reach the last gate in the gate array. While the data for the next subframe is shifted, the pixels may be in the emission phase, and the data movement through the gate array would not affect the pixel emission.

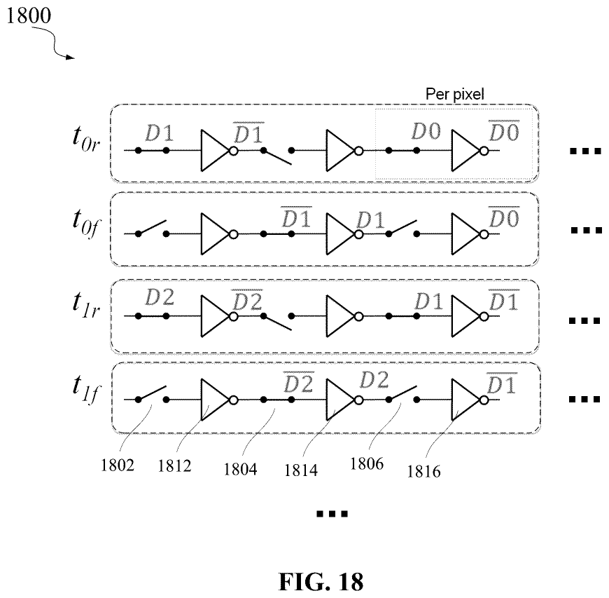

FIG. 18 illustrates examples of operations of transmission gates on a data line 1800 of an example of a digital matrix display in a page writing period (or emission period) according to certain embodiments. Data line 1800 may include an array of gates connected serially by an array of switches. FIG. 18 only shows 3 gates and 3 switches of data line 1800. Data line 1800 can be implemented using different digital circuitry. The transmission gate array shown in FIG. 18 is one example of the circuitry for clock-synchronized data transfer, where inverters are used as the transmission gates. The transmission gate array may be fast and may need a small area. Digital circuits using more transistors such as D-latch and flip-flops can be more stable design options for the data line.

In the example illustrated in FIG. 18, at the positive clock edge of a first clock cycle (e.g., rising edge T₀ᵣ), the odd-number switches (e.g., including a first switch 1802 and a third switch 1806) may be turned on and the even-number switches (e.g., including a second switch 1804) may be turned off, such that a first gate 1812 (e.g., an inverter) may get input data D1 from a data driver or a previous gate and have data D̅1̅ at the output, and a third gate 1816 (e.g., an inverter) may get input data D0 from a second gate 1814 and have data D̅0̅ at the output. At the negative clock edge of the first clock cycle (e.g., T_{0f}), the odd-number switches (e.g., first switch 1802 and third switch 1806) may be turned off and the even-number switches (e.g., second switch 1804) may be turned on, such that second gate 1814 (e.g., an inverter) may get input data D̅1̅ from first gate 1812 and have data D1 at the output, while outputs at first gate 1812 and third gate 1816 may remain unchanged (e.g., data D̅1̅ and data D̅0̅, respectively). Therefore, after the first clock cycle, D1 may be at the output of second gate 1814 and D̅0̅ may be at the output of third gate 1816.

At the positive clock edge of a second clock cycle (e.g., rising edge T₁ᵣ), the odd-number switches (e.g., including first switch 1802 and third switch 1806) may again be turned on and the even-number switches (e.g., including second switch 1804) may be turned off, such that first gate 1812 may get input data D2 from a data driver or a previous gate and have data D̅2̅ at the output, and third gate 1816 may get input data D1 from a second gate 1814 and have data D̅1̅ at the output. At the negative clock edge of the second clock cycle (e.g., T_{1f}), the odd-number switches (e.g., first switch 1802 and third switch 1806) may be turned off and the even-number switches (e.g., second switch 1804) may be turned on, such that second gate 1814 (e.g., an inverter) may get input data D̅2̅ from first gate 1812 and have data D2 at the output, while outputs at first gate 1812 and third gate 1816 may remain unchanged (e.g., data D̅1̅ and data D̅0̅, respectively). Therefore, after the second clock cycle, D2 may be at the output of second gate 1814 and D̅1̅ may be at the output of third gate 1816. In this way, the data bits for a page (e.g., a subframe) may be shifted into a gate array at a rate of one bit per clock cycle.

As shown in FIGS. 16-18, in the system aspect, the digital matrix display disclosed herein may not have a direct control to the pixel through the gate and data signals. The scan switch and emission control signals may be global, and the circuit operations may be synchronized to the clock signal. In some embodiments, an emission control transistor may be shared by adjacent pixels. In some embodiments where the panel system allows ELVDD signal swing, the emission control signal may not be needed, and all pixels in the digital matrix can share the same emission control transistor. The differences between the active matrix displays and the digital matrix displays disclosed herein may also be shown by the timing diagrams.

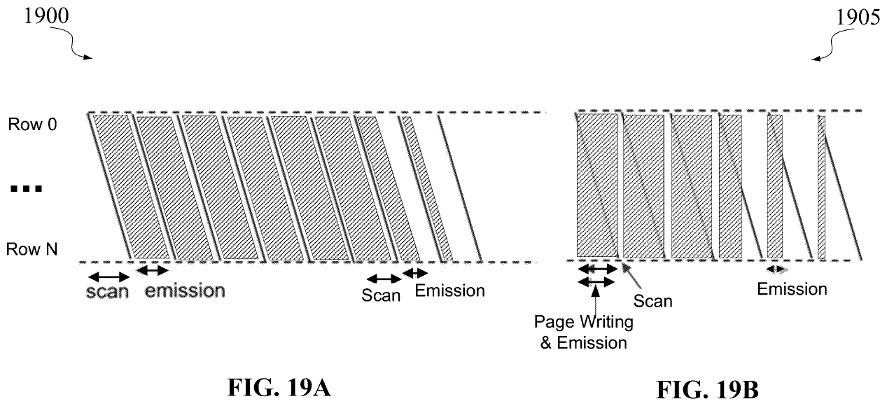

FIG. 19A includes a timing diagram 1900 of an image frame including multiple subframes for an example of an active matrix display. The active matrix display may be similar to digital driving display 1105 of FIG. 11B. The digital driving scheme shown in FIG. 19A may be similar to the subframe driving method shown in FIG. 12C, where the subframes for the MSBs and the subframes for the LSBs may have the same duration and the LSBs may be implemented using different duty cycles. As shown in FIG. 19A and as described above with respect to, for example, FIG. 11B, pixels in different rows of digital driving display 1105 may be selected (e.g., by a gate driver) to receive data at different time in a rolling manner (e.g., one row at a time) and may also emit light at different time in each subframe.

FIG. 19B includes a timing diagram 1905 of an image frame including multiple subframes for an example of a digital matrix display disclosed herein according to certain embodiments. The digital matrix display may be similar to digital matrix display 1300 of FIG. 13A or digital matrix display 1305 of FIG. 13B. The digital driving scheme shown in FIG. 19B may be similar to the subframe driving method shown in FIG. 12C, where the subframes for the MSBs and the subframes for the LSBs may have the same duration and the LSBs may be implemented using different duty cycles. As shown in FIG. 19B, in the DM displays disclosed herein, data scan (data transfer from gates to memory cells for the pixels) may be performed simultaneously for all pixels in the digital matrix display, and emission may occur simultaneously for all pixels of the digital matrix display. The page writing period may overlap the emission period.

For an example of a 4K×4K×3 (RGB) panel operating at 90 Hz with 20 subframes for each frame, each subframe time is about 555 s, and 48,000,000 bits of data (4K×4K×3 bits) may be transferred during one subframe time. With 4K×3 (RGB) columns and inverters used as the gates, 4K data bits may be transferred in each column during one sub frame time. Therefore, one bit may need to be moved to the next gate in about 138 ns, and the clock speed in each gate array can be about 3.6 MHz in the transmission gate array (or reduced to a half if utilizing both rising and falling edge). In embodiments where the data driver for subframe conversion (e.g., a DDIC) is placed outside of the digital matrix chip as shown in, for example, FIG. 13A, 86,400,000,000 bits of display data for 90 frames (each including 20 subframes) may need to be delivered in one second, which may be achieved using a 32-bit data bus having a data rate about 2.7 Gbps on each bus line with a simple transition method. If the data driver for subframe conversion (e.g., DDIC) is in the digital matrix chip as shown in FIG. 13B, in each second, 34,560,000,000 bits of data for 90 frames each including 4K×4K 8-bit RGB image data can be transmitted to the digital matrix chip through a 32-bit data bus having a data rate about 1.0 Gbps on each bus line. In either embodiment, the data bits may be shifted at, for example, about 3.6 MHz internally along a data line in the digital matrix chip as described above.

One additional advantage of the digital driving techniques disclosed herein is that separated data drivers may be used. In analog driving, the data mismatch between the data drivers, the power consumption, and the cost are some technical bottlenecks of the data drivers. Digital driving does not have the mismatch problem and power and cost issue in digital data drivers. Moreover, the digital matrix may enable sub-block driving.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

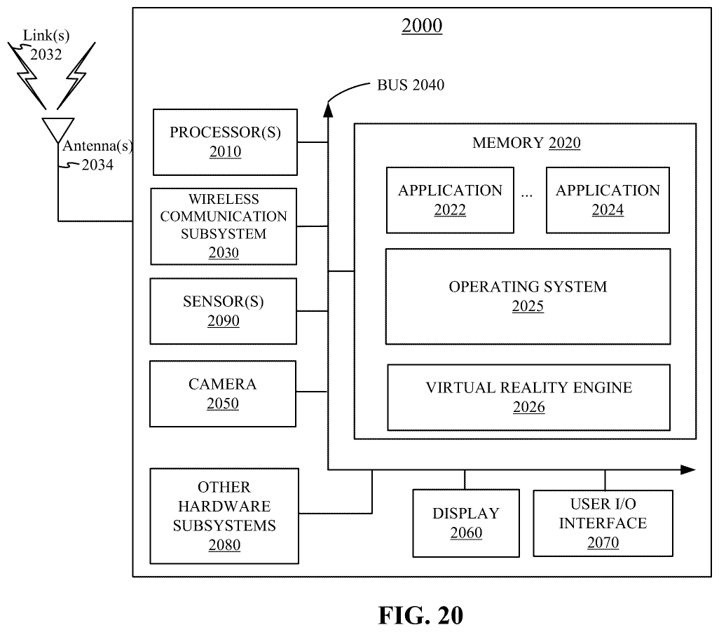

FIG. 20 is a simplified block diagram of an example of an electronic system 2000 of an example near-eye display (e.g., HMD device) for implementing some of the examples disclosed herein. Electronic system 2000 may be used as the electronic system of an HMD device or other near-eye displays described above. In this example, electronic system 2000 may include one or more processor(s) 2010 and a memory 2020. Processor(s) 2010 may be configured to execute instructions for performing operations at a number of components, and can be, for example, a general-purpose processor or microprocessor suitable for implementation within a portable electronic device. Processor(s) 2010 may be communicatively coupled with a plurality of components within electronic system 2000. To realize this communicative coupling, processor(s) 2010 may communicate with the other illustrated components across a bus 2040. Bus 2040 may be any subsystem adapted to transfer data within electronic system 2000. Bus 2040 may include a plurality of computer buses and additional circuitry to transfer data.

Memory 2020 may be coupled to processor(s) 2010. In some embodiments, memory 2020 may offer both short-term and long-term storage and may be divided into several units. Memory 2020 may be volatile, such as static random access memory (SRAM) and/or dynamic random access memory (DRAM) and/or non-volatile, such as read-only memory (ROM), flash memory, and the like. Furthermore, memory 2020 may include removable storage devices, such as secure digital (SD) cards. Memory 2020 may provide storage of computer-readable instructions, data structures, program code, and other data for electronic system 2000. In some embodiments, memory 2020 may be distributed into different hardware subsystems. A set of instructions and/or code might be stored on memory 2020. The instructions might take the form of executable code that may be executable by electronic system 2000, and/or might take the form of source and/or installable code, which, upon compilation and/or installation on electronic system 2000 (e.g., using any of a variety of generally available compilers, installation programs, compression/decompression utilities, etc.), may take the form of executable code.

In some embodiments, memory 2020 may store a plurality of applications 2022 through 2024, which may include any number of applications. Examples of applications may include gaming applications, conferencing applications, video playback applications, or other suitable applications. The applications may include a depth sensing function or eye tracking function. Applications 2022-2024 may include particular instructions to be executed by processor(s) 2010. In some embodiments, certain applications or parts of applications 2022-2024 may be executable by other hardware subsystems 2080. In certain embodiments, memory 2020 may additionally include secure memory, which may include additional security controls to prevent copying or other unauthorized access to secure information.

In some embodiments, memory 2020 may include an operating system 2025 loaded therein. Operating system 2025 may be operable to initiate the execution of the instructions provided by applications 2022-2024 and/or manage other hardware subsystems 2080 as well as interfaces with a wireless communication subsystem 2030 which may include one or more wireless transceivers. Operating system 2025 may be adapted to perform other operations across the components of electronic system 2000 including threading, resource management, data storage control and other similar functionality.

Wireless communication subsystem 2030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2000 may include one or more antennas 2034 for wireless communication as part of wireless communication subsystem 2030 or as a separate component coupled to any portion of the system. Depending on desired functionality, wireless communication subsystem 2030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2030 may permit data to be exchanged with a network, other computer systems, and/or any other devices described herein. Wireless communication subsystem 2030 may include a means for transmitting or receiving data, such as identifiers of HMD devices, position data, a geographic map, a heat map, photos, or videos, using antenna(s) 2034 and wireless link(s) 2032.

Embodiments of electronic system 2000 may also include one or more sensors 2090. Sensor(s) 2090 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 2090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2000 may include a display 2060. Display 2060 may be a near-eye display, and may graphically present information, such as images, videos, and various instructions, from electronic system 2000 to a user. Such information may be derived from one or more applications 2022-2024, virtual reality engine 2026, one or more other hardware subsystems 2080, a combination thereof, or any other suitable means for resolving graphical content for the user (e.g., by operating system 2025). Display 2060 may use liquid crystal display (LCD) technology, light-emitting diode (LED) technology (including, for example, OLED, ILED, micro-LED, AMOLED, TOLED, etc.), light emitting polymer display (LPD) technology, or some other display technology.

Electronic system 2000 may include a user input/output interface 2070. User input/output interface 2070 may allow a user to send action requests to electronic system 2000. An action request may be a request to perform a particular action. For example, an action request may be to start or end an application or to perform a particular action within the application. User input/output interface 2070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2000. In some embodiments, user input/output interface 2070 may provide haptic feedback to the user in accordance with instructions received from electronic system 2000. For example, the haptic feedback may be provided when an action request is received or has been performed.

Electronic system 2000 may include a camera 2050 that may be used to take photos or videos of a user, for example, for tracking the user's eye position. Camera 2050 may also be used to take photos or videos of the environment, for example, for VR, AR, or MR applications. Camera 2050 may include, for example, a complementary metal-oxide-semiconductor (CMOS) image sensor with a few millions or tens of millions of pixels. In some implementations, camera 2050 may include two or more cameras that may be used to capture 3-D images.

In some embodiments, electronic system 2000 may include a plurality of other hardware subsystems 2080. Each of other hardware subsystems 2080 may be a physical subsystem within electronic system 2000. While each of other hardware subsystems 2080 may be permanently configured as a structure, some of other hardware subsystems 2080 may be temporarily configured to perform specific functions or temporarily activated. Examples of other hardware subsystems 2080 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 2080 may be implemented in software.

In some embodiments, memory 2020 of electronic system 2000 may also store a virtual reality engine 2026. Virtual reality engine 2026 may execute applications within electronic system 2000 and receive position information, acceleration information, velocity information, predicted future positions, or some combination thereof of the HMD device from the various sensors. In some embodiments, the information received by virtual reality engine 2026 may be used for producing a signal (e.g., display instructions) to display 2060. For example, if the received information indicates that the user has looked to the left, virtual reality engine 2026 may generate content for the HMD device that mirrors the user's movement in a virtual environment. Additionally, virtual reality engine 2026 may perform an action within an application in response to an action request received from user input/output interface 2070 and provide feedback to the user. The provided feedback may be visual, audible, or haptic feedback. In some implementations, processor(s) 2010 may include one or more GPUs that may execute virtual reality engine 2026.

In various implementations, the above-described hardware and subsystems may be implemented on a single device or on multiple devices that can communicate with one another using wired or wireless connections. For example, in some implementations, some components or subsystems, such as GPUs, virtual reality engine 2026, and applications (e.g., tracking application), may be implemented on a console separate from the head-mounted display device. In some implementations, one console may be connected to or support more than one HMD.

In alternative configurations, different and/or additional components may be included in electronic system 2000. Similarly, functionality of one or more of the components can be distributed among the components in a manner different from the manner described above. For example, in some embodiments, electronic system 2000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A display drive circuit comprising a plurality of lines of cells, a line of cells of the plurality of lines of cells comprising:
a plurality of pixel drive circuits for a plurality of light emitters; and
a data line including an array of data bit storage devices connected serially and configured to shift display data bits along the data line, an output of each data bit storage device of the array of data bit storage devices connected to a corresponding pixel drive circuit of the plurality of pixel drive circuits.

2. The display drive circuit of claim 1, wherein each line of cells of the plurality of lines of cells includes a column or a row of cells.

3. The display drive circuit of claim 1, wherein the data line includes an array of switches interleaved with the array of data bit storage devices.

4. The display drive circuit of claim 3, wherein even-number switches in the array of switches are configured to switch at a different time from a switch time of odd-number switches in the array of switches.

5. The display drive circuit of claim 3, wherein:
even-number switches in the array of switches are configured to be switched by a first control signal or a first edge of a control signal; and
odd-number switches in the array of switches are configured to be switched by a second control signal or a second edge of the control signal.

6. The display drive circuit of claim 1, wherein each data bit storage device of the array of data bit storage devices includes an inverter, a transmission gate, a latch, a flip-flop, a register, a memory cell, or a digital buffer.

7. The display drive circuit of claim 1, wherein each pixel drive circuit of the plurality of pixel drive circuits includes:
a digital memory cell electrically connected to a respective data bit storage device of the array of data bit storage devices and configured to store a display data bit from the output of the data bit storage device; and
a first switch controlled by the display data bit stored in the digital memory cell to turn on or off a drive current to a respective light emitter of the plurality of light emitters.

8. The display drive circuit of claim 7, wherein the digital memory cell includes a static random access memory (SRAM) cell.

9. The display drive circuit of claim 7, wherein the first switch includes a transistor.

10. The display drive circuit of claim 7, wherein the digital memory cell is connected to the respective data bit storage device through a second switch in each cell of the line of cells.

11. The display drive circuit of claim 10, wherein second switches in each line of cells are controlled by a same control signal.

12. The display drive circuit of claim 10, wherein second switches in the plurality of lines of cells are controlled by a same control signal.

13. The display drive circuit of claim 10, wherein each pixel drive circuit of the plurality of pixel drive circuits further includes a transmission control switch connecting the first switch to a power source.

14. The display drive circuit of claim 13, wherein transmission control switches in each line of cells are controlled by a first control signal that is opposite to a second control signal that controls second switches in the line of cells.

15. The display drive circuit of claim 1, further comprising a data driver circuit at a peripheral region of the display drive circuit, the data driver circuit connected to the plurality of lines of cells.

16. The display drive circuit of claim 15, wherein the data driver circuit includes a plurality of data drivers configured to drive different lines of cells of the plurality of lines of cells.

17. The display drive circuit of claim 15, wherein:
the data driver circuit is configured to provide display data bits for an image frame subframe-by-subframe in a plurality of subframes; and
display data bits for each subframe of the plurality of subframes include one data bit for each cell in the plurality of lines of cells.

18. A display drive circuit comprising a plurality of lines of cells, wherein:
each cell of a line of cells of the plurality of lines of cells includes:
a data bit storage device;
a digital memory cell electrically coupled to an output of the data bit storage device and configured to store a display data bit from the output of the data bit storage device; and
a switch controlled by the display data bit stored in the digital memory cell to turn on or off a drive current for a light emitter; and
data bit storage devices of the line of cells are serially connected to form a data line that is capable of shifting display data bits along the data line.

19. A display panel comprising a plurality of lines of cells, a line of cells of the plurality of lines of cells comprising:
a plurality of light emitters;
a plurality of pixel drive circuits for the plurality of light emitters, each pixel drive circuit of the plurality of pixel drive circuits coupled to a respective light emitter of the plurality of light emitters; and
a data line including an array of data bit storage devices connected serially and configured to shift display data bits along the data line, an output of each data bit storage device of the array of data bit storage devices connected to a corresponding pixel drive circuit of the plurality of pixel drive circuits.

20. The display panel of claim 19, wherein a light emitter of the plurality of light emitters includes an organic light-emitting diode (OLED), a micro-OLED, a light-emitting diode (LED), or a micro-LED.
